(19) United States
(12) Patent Application Publication
(10) Pub. No.: US 2010/0289387 A1
(43) Pub. Date: Nov. 18, 2010

(54) Rotation detecting apparatus and direct current motor

(75) Inventors: Ken Tanaka, Nukata-gun (JP); Kenji Takeda, Okazaki-city (JP); Tsutomu Nakamura, Kariya-city (JP); Masaru Touge, Kariya-city (JP); Yuuki Matsumoto, Kariya-city (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Nippon Soken, Inc., Nishio-city (JP)

(21) Appl. No.: 12/800,354

(22) Filed: May 13, 2010

(30) Foreign Application Priority Data
May 15, 2009 (JP) 2009-118769
Feb. 24, 2010 (JP) 2010-039125

(51) Int. Cl. H02K 11/00

(52) U.S. Cl. 310/68 B

(57) ABSTRACT

A rotation detecting apparatus includes a direct-current motor, a power source part, an energization detecting part, and a rotation state detecting part. The direct-current motor is configured so that an inductance between a pair of brushes periodically changes in accordance with a rotation. The power source part applies a power source voltage between the pair of brushes. In the power source voltage, an alternating-current voltage is superimposed on a direct-current voltage. The energization detecting part detects an electric quantity related to the alternating-current voltage applied from the power source part to the direct-current motor. The rotation state detecting part detects at least one of a rotation angle, a rotation direction, and a rotation speed of the direct-current motor based on a change in an amplitude of an alternating-current component in the electric quantity detected by the energization detecting part.

### CROSS REFERENCE TO RELATED APPLICATIONS

The present application is based on and claims priority to Japanese Patent Applications No. 2009-118769 filed on May 15, 2009, and No. 2010-039125 filed on Feb. 24, 2010, the contents of which are incorporated in their entirety herein by reference.

### BACKGROUND OF THE INVENTION

1. Field of the Invention

The present invention relates to a rotation detecting apparatus for detecting a rotation state of a direct-current motor. The present invention also relates to a direct-current motor whose rotation state is detectable.

2. Description of the Related Art

Conventionally, a brushed direct-current motor has been used for a vehicle. For example, in an air conditioner of a vehicle, a brushed direct-current motor can be used for controlling opening angles of an air mix damper for controlling temperature and a mode damper for switching outlets. In order to control the opening angles of the dampers with a high degree of accuracy, a rotation state of the direct-current motor including a rotation angle, a rotation direction, and a rotation speed is detected, and the opening angles are controlled based on the rotation state.

In a general method of detecting a rotation state of a direct-current motor, a sensor including a rotary encoder and a potentiometer is provided and the rotation state is detected based on a detection signal from the sensor. Also in a vehicle, such a sensor is provided for detecting a rotation state.

However, the method of detecting the rotation state by providing the sensor needs a space where a sensor is disposed for each direct-current motor. Furthermore, a harness for transmitting the detection signal of the sensor to another device (for example, an in-vehicle ECU) is required for each direct-current motor in addition to a harness for supplying direct-current power to each motor. Thus, a weight and a cost of the vehicle increase. As a result, a demand for developing a sensorless method is increased for reducing the number of sensors and harnesses.

Various sensorless methods for detecting a rotation state of a direct-current motor without using a sensor such as a rotary encoder are suggested. In a method, a rotation state of a direct-current motor is detected by detecting a surge pulse that is caused when a positional relationship between a commutator and brushes are changed. When the motor starts rotating or stops rotating, the motor rotates at a low speed, an electromotive force of the motor becomes small, and the surge pulse becomes small. Thus, the surge pulse is difficult to be detected when the rotation speed is low.

In another sensorless method, a resistor is coupled between two segments in a plurality of segments formed in a commutator so as to be parallel to a phase coil coupled between the two segments, and a rotation pulse is detected based on electric current that flows between the two segments as disclosed, for example, in JP-A-2003-111465.

In the sensorless method disclosed in JP-A-2003-111465, a resistor is coupled in parallel with one of phase coils. When direct current is supplied to a motor circuit (a circuit on a side of an armature including a plurality of phase coils) through a brush, electric current that flows between brushes periodically changes in accordance with a rotation angle of the motor. By detecting the rotation pulse based on the change in the electric current, the detection accuracy can be improved compared with the above-described detection method based on the surge pulse.

However, in the above-described method, since the change in the direct current that flows in the motor circuit is caused by coupling the resistor with one of the phase coils, a torque fluctuation is caused in accordance with the change in the direct current. The torque fluctuation may cause noise of the motor or noise of an object driven by the motor.

Furthermore, also in the above-described method, it is difficult to detect the change in the electric current when the rotation speed is low.

### SUMMARY OF THE INVENTION

In view of the foregoing problems, it is an object of the present invention to provide a rotation detecting apparatus that can detect a rotation state of a direct-current motor with a high degree of accuracy regardless of a rotation speed.

Another object of the present invention is to provide a direct-current motor whose rotation state can be detected with a high degree of accuracy regardless of a rotation speed.

A rotation detecting apparatus according to an aspect of the present invention includes a direct-current motor, a power source part, an energization detecting part, and a rotation state detecting part. The direct-current motor includes a housing, a plurality of magnets, a rotor core, a commutator, and a pair of brushes. The plurality of magnets is fixed on an inner surface of the housing and is arranged in a circumferential direction of the housing. The rotor core is disposed in the housing and includes an armature coil having a plurality of phase coils. The commutator includes a plurality of commutator segments coupled with the armature coil. The pair of brushes slidingly contacts the commutator. The direct-current motor is configured so that an inductance between the pair of brushes periodically changes in accordance with a rotation of the rotor core. The power source part is configured to apply a power source voltage between the pair of brushes. In the power source voltage, an alternating-current voltage is superimposed on a direct-current voltage. The energization detecting part is configured to detect an electric quantity related to the alternating-current voltage applied from the power source part to the direct-current motor. The rotation state detecting part is configured to detect at least one of a rotation angle, a rotation direction, and a rotation speed of the direct-current motor based on a change in an amplitude of an alternating-current component in the electric quantity detected by the energization detecting part.

The rotation detecting apparatus can detect the rotation state of the direct-current motor with a high degree of accuracy regardless of a rotation speed.

A direct-current motor according to another aspect of the present invention includes a housing, a plurality of magnets, a rotor core, a commutator, and a pair of brushes. The plurality of magnets is fixed on an inner surface of the housing and is arranged in a circumferential direction of the housing. The rotor core is disposed in the housing and includes an armature coil having a plurality of phase coils. The commutator includes a plurality of commutator segments coupled with the armature coil. The pair of brushes slidingly contacts the commutator. An inductance between the pair of brushes periodically changes in accordance with a rotation of the rotor core.

A rotation state of the direct-current motor can be detected with a high degree of accuracy regardless of a rotation speed.

### BRIEF DESCRIPTION OF THE DRAWINGS

Additional objects and advantages of the present invention will be more readily apparent from the following detailed description of exemplary embodiments when taken together with the accompanying drawings. In the drawings:

FIG. 1A is diagram showing a rotation detecting apparatus according to a first embodiment of the present invention and FIG. 1B is a diagram showing a motor circuit;

FIG. 2A is a diagram showing a motor according to the first embodiment in a state IIA where one of teeth of a rotor core is opposite a protruding portion and FIG. 2B is a diagram showing the motor in a state IIB where none of the teeth is opposite the protruding portion;

FIG. 3 is a diagram showing an example of a waveform of an electric current that flows in the motor according to the first embodiment when the motor is rotating;

FIG. 4 is a block diagram showing a rotation signal detecting part in the rotation detecting apparatus according to the first embodiment;

FIG. 5A is a diagram showing an example of a waveform of an electric current that flows in the motor according to the first embodiment, and FIG. 5B is a diagram showing an example of a rotation pulse generated in the rotation detecting apparatus according to the first embodiment;

FIG. 6A is a diagram showing a motor according to a second embodiment of the present invention and FIG. 6B is a diagram showing an example of a waveform of an electric current that flows in the motor when the motor is rotating;

FIG. 7A is a diagram showing a motor according to a third embodiment of the present invention and FIG. 7B is a diagram showing an example of a waveform of an electric current that flows in the motor when the motor is rotating;

FIG. 8 is a diagram showing a motor according to a fourth embodiment of the present invention;

FIG. 9A is a diagram showing a motor according to a fifth embodiment of the present invention and FIG. 9B is a diagram showing an example of a waveform of an electric current that flows in the motor when the motor is rotating;

FIG. 10A is a diagram showing a motor according to a sixth embodiment of the present invention and FIG. 10B is a diagram showing an example of a waveform of an electric current that flows in the motor when the motor is rotating;

FIG. 11 is a diagram showing a motor according to a seventh embodiment of the present invention;

FIG. 12A is a diagram showing a motor according to an eighth embodiment of the present invention and FIG. 12B is a diagram showing a motor circuit;

FIG. 13A is a diagram showing the motor circuit in a state XIIIA, and FIG. 13B is a circuit diagram showing the motor circuit in the state XIIIA;

FIG. 13C is a diagram showing the motor circuit in a state XIIIC, and FIG. 13D is a circuit diagram showing a motor circuit in the state XIIIC;

FIG. 13E is a diagram showing the motor circuit in a state XIIIE, and FIG. 13F is a circuit diagram showing the motor circuit in the state XIIIE;

FIG. 14 is a diagram showing an example of a waveform of an electric current that flows in the motor according to the eighth embodiment when the motor is rotating;

FIG. 15 is a diagram showing a motor circuit in a motor according to a ninth embodiment of the present invention;

FIG. 16 is a diagram showing a motor circuit in a motor according to a tenth embodiment of the present invention;

FIG. 17 is a diagram showing a motor circuit in a motor according to an eleventh embodiment of the present invention;

FIG. 18 is diagram showing a rotation detecting apparatus according to a twelfth embodiment of the present invention;

FIG. 19A is a diagram showing relationships between a frequency and an impedance of a parallel resonance circuit in the state IIA and the state IIB, and FIG. 19B is a diagram showing relationships between a frequency and an impedance of a motor in the state IIA and the state IIB;

FIG. 20 is a diagram showing an example of a waveform of an electric current that flows in a motor according to the twelfth embodiment when the motor is rotating;

FIG. 21 is a diagram showing a rotation detecting apparatus according to a modification of the twelfth embodiment;

FIG. 22 is a diagram showing a rotation detecting apparatus according to a thirteenth embodiment of the present invention;

FIG. 23A is a diagram showing a waveform of an alternating-current voltage having a rectangular waveform and a waveform of an alternating current superimposed through a coupling capacitor, and FIG. 23B is a diagram showing a waveform (XXIIIA) of the superimposed alternating current in a case where the alternating-current voltage has the rectangular waveform and a waveform (XXIIIB) of a superimposed alternating current in a case where an alternating-current voltage has a sine waveform;

FIG. 24A is a diagram showing a frequency spectrum of the superimposed alternating current in a case where the alternating-current voltage having the rectangular wave form is applied through a coupling capacitor, and FIG. 24B is a diagram showing a frequency spectrum of the superimposed alternating current in a case where the alternating-current voltage having the sine waveform is applied through a coupling capacitor; and

FIG. 25 is a diagram showing an example of a waveform of an electric current that flows in a motor according to the thirteenth embodiment when the motor is rotating.

### DETAILED DESCRIPTION OF THE EXEMPLARY EMBODIMENTS

### First Embodiment

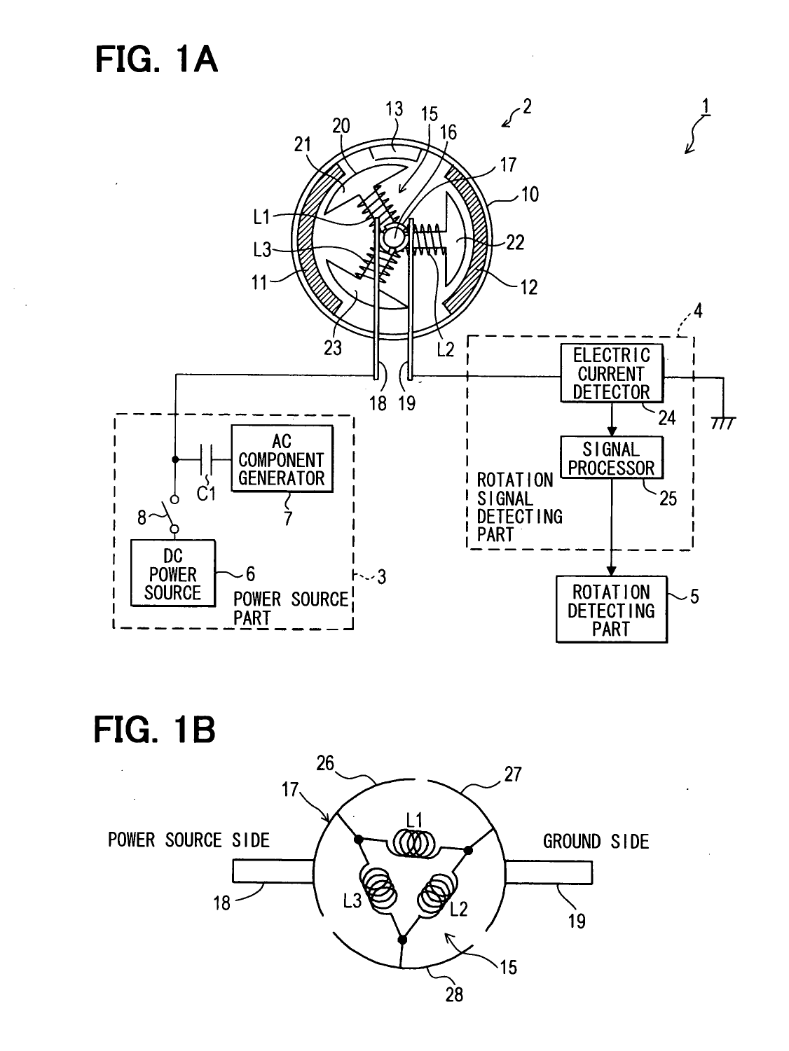

A rotation detecting apparatus 1 according to a first embodiment of the present invention will be described with reference to FIG. 1A. The rotation detecting apparatus 1 includes a motor 2, a power source part 3, a rotation signal detecting part 4, and a rotation detecting part 5. The motor 2 is a permanent magnet direct-current motor. The rotation signal detecting part 4 generates a rotation pulse in accordance with a rotation state of the motor 2 based on electric current that flows in the motor 2 and outputs the rotation pulse. The rotation detecting part 5 detects the rotation state of the motor 2 based on the rotation pulse from the rotation signal detecting part 4.

The rotation detecting part 5 can be configured to detect at least one of a rotation angle, a rotation direction, and a rotation speed as the rotation state of the motor 2. Because the rotation detecting apparatus 1 according present embodiment includes one protruding portion 13 in the motor 2, the rotation detecting part 5 can detect at least the rotation angle of the motor 2. The rotation detecting apparatus 1 may also include a component for detecting the rotation direction and the rotation speed.

The rotation detecting apparatus 1 according to the present embodiment can be used, for example, for detecting a rotation angle of a motor that drives each damper in an air conditioning apparatus in a vehicle.

The power source part 3 includes a direct-current power source 6, an alternating-current component generator 7, a coupling capacitor C1, and a switch 8. The direct-current power source 6 generates a direct-current voltage for driving the motor 2. The alternating-current component generator 7 generates an alternating-current voltage having a predetermined frequency for detecting the rotation state of the motor 2. The coupling capacitor C1 superimposes the alternating-current voltage generated by the alternating-current component generator 7 on the direct-current voltage from the direct-current power source 6 and supplies the superimposed alternating-current and direct-current voltage to the motor 2. The switch 8 connects and disconnects an energizing path from the direct-current power source 6 to the motor 2. The alternating-current voltage generated by the alternating-current component generator 7 may have various waveforms including a sine waveform, a rectangular waveform, and a triangular waveform.

The motor 2 includes a power-source side brush 18 and a ground side brush 19. The power-source side brush 18 is coupled with the power source part 3. The ground side brush 19 is coupled with the ground through the rotation signal detecting part 4. When the motor 2 rotates, by turning on the switch 8, the superimposed voltage (power source voltage) is applied to the armature coil 15 of the motor 2 through the brushes 18 and 19. Accordingly, a mixed current of the alternating current and the direct current flows to the armature coil 15.

Since the motor 2 is the direct-current motor, in the mixed current of the alternating current and the direct current, a component that gives torque to the motor 2 for rotating the motor 2 is a direct-current component due to the direct-current voltage applied from the direct-current power source 6. An alternating-current component due to the alternating-current voltage applied from the alternating-current component generator 7 is not concerned with the rotation of the motor 2 and does not influence the torque. In the present embodiment, the alternating-current voltage from the alternating-current component generator 7 is applied to the motor 2 for detecting the rotation angle of the motor 2. The rotation signal detecting part 4 generates the rotation pulse based on the alternating-current component in the mixed current that flows in the motor 2. That is, the alternating-current component generator 7 is provided for detecting the rotation state of the motor 2 not for rotating the motor 2.

When an operation for stopping the rotation of the motor 2 is performed, the switch 8 is turned off and the direct-current voltage from the direct-current power source 6 to the motor 2 is cut off. The alternating-current component generator 7 keeps, applying the alternating-current voltage to the motor 2 even when the operation for stopping the rotation of the motor 2 is performed. That is, the alternating-current component generator 7 keeps applying the alternating-current voltage to the motor 2 at least while the motor 2 is rotating.

The motor 2 includes a housing 10 and a rotor core 20 housed in the housing 10. The rotor core 20 is fixed to a rotation shaft 16 disposed on an axial center of the housing 10 and rotates with the rotation shaft 16.

The housing 10 has an approximately cylindrical shape. On an inner surface of the housing 10, two magnets 11 and 12 for generating a magnetic field are fixed so as to oppose each other in a radial direction of the housing 10. In a circumferential direction, the two magnets 11 and 12 are apart from each other.

The magnets 11 and 12 are permanent magnets. One of the magnets 11 and 12 has a north pole on a side opposite to the rotor core 20 and the other one of the magnets 11 and 12 has a south pole on a side opposite to the rotor core 20. That is, the motor 2 according to the present embodiment is a direct current motor having a two-pole electric field.

The housing 10 is a yoke made of a soft magnetic material. The housing 10 forms a magnetic circuit of the motor 2 with the magnets 11 and 12 fixed to the inner surface of the housing 10. The rotor core 20 is made of a soft magnetic material. The rotor core 20 includes a first tooth 21, a second tooth 22, and a third tooth 23. The armature coil 15 includes a first phase coil L1, a second phase coil L2, and a third phase coil L3. The first phase coil L1, the second phase coil L2, and the third phase coil L3 are wound to the first tooth 21, the second tooth 22, and the third phase coil L3, respectively.

A commutator 17 is fixed to the rotation shaft 16. The power-source side brush 18 and the ground side brush 19 are opposite to each other, that is, the power source side brush 18 and the ground side brush 19 are at 180 degrees from each other in a rotation direction. The brushes 18 and 19 slidingly contact the commutator 17.

The commutator 17 includes a first commutator segment 26, a second commutator segment 27, and a third commutator segment 28. The commutator segments 26-28 slidingly contact the brushes 18 and 19. The phase coils L1-L3 in the armature coil 15 have a delta connection with the commutator segments 26-28.

The first phase coil L1 is coupled between the first commutator segment 26 and the second commutator segment 27. The second phase coil L2 is coupled between the second commutator segment 27 and the third commutator segment 28. The third phase coil L3 is coupled between the third commutator segment 28 and the first commutator segment 26. The phase coils L1-L3 have substantially the same inductance. The phase coils L1-L3 are at 2π/3 degrees in an electric angle from each other.

Two (momentarily, three) of the commutator segments 26-28 come in contact with the brushes 18 and 19. Since the commutator 17 rotates with the rotation of the motor 2, the commutator segment being in contact with each of the brushes 18 and 19 changes.

The power source voltage output from the power source part 3 is applied between the brushes 18 and 19. Then, through the brushes 18 and 19 and the commutator segments being in contact with the brushes 18 and 19, electric current flows to the motor circuit located between the brushes 18 and 19. The motor circuit includes the phase coils L1-L3 in the motor 2.

The inner surface of the housing 10 has two clearance regions between the magnets 11 and 12 in the circumferential direction. In the motor 2 according to the present embodiment, a protruding portion 13 protrudes radially inward from one of the clearance regions. In the circumferential direction, the protruding portion 13 is apart from both of the magnets 11 and 12 so that the protruding portion 13 is not in contact with the magnets 11 and 12.

The protruding portion 13 is made of a soft magnetic material. The protruding portion 13 has a predetermined length in the circumferential direction and has a predetermined width in a radial direction. Due to the protruding portion 13, a magnetic resistance of a magnetic circuit formed by the rotor core 20 and the housing 10 of the motor 2 changes in accordance with the rotation of the rotor core 20. In the following description, “magnetic resistance” means the magnetic resistance of the magnetic circuit formed by the rotor core 20 and the housing 10 of the motor 2 unless otherwise noted.

As described above, the rotor core 20 and the housing 10 are made of the soft magnetic material. Thus, a magnetic permeability the rotor core 20 and the housing 10 are much larger than a magnetic permeability of air. Thus, the magnetic resistance of the motor 2 depends on air gap between each of the teeth 21-23 and the inner surface of the housing 10 or the magnets 11 and 12, and the sum of thicknesses of the magnets 11 and 12. The magnetic resistance increases as the air gap becomes larger, and the magnetic resistance decreases as the air gap becomes smaller.

A magnetic permeability of each of the magnets 11 and 12 is substantially the same as the magnetic permeability of air. Thus, from a standpoint of magnetism, each of the magnets 11 and 12 is equivalent of air. That is, when the magnetic resistance of the motor 2 is considered, the presence of the magnets 11 and 12 having substantially the same magnetic permeability as air can be neglected, and the magnets 11 and 12 can be regarded as air gap. Therefore, if the protruding portion 13 is not provided, the air gap between the rotor core 20 and the inner surface of housing 10 is constant even when the rotor core 20 rotates, and the magnetic resistance does not change in accordance with the rotation of the rotor core 20.

In the motor 2 according to the present embodiment, the protruding portion 13 is provided on the inner surface of the housing 10. The protruding portion 13 has a magnetic permeability substantially the same as the housing 10. Thus, the magnetic resistance of the motor 2 depends on whether an outer peripheral surface of each of the teeth 21-23 in the rotor core 20 is opposite the protruding portion 13. That is, the magnetic resistance changes in accordance with the rotation of the motor 2. When the magnetic resistance changes, an inductance of the motor circuit also changes. Thus, in the electric current that flows in the motor circuit, an amplitude of the alternating-current component changes.

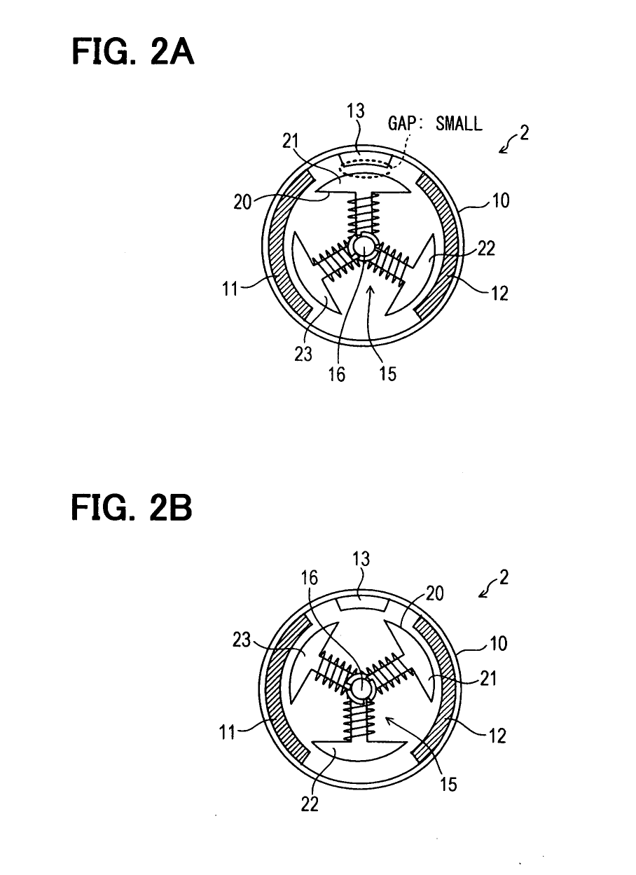

A relationship between the rotation state (rotation angle) of the motor 2 and the inductance of the motor circuit will be described with reference to FIG. 2A and FIG. 2B. In a state IIA, the whole region of an inner surface of the protruding portion 13 is opposite the outer peripheral surface of the first tooth 21 of the rotor core 20 as shown in FIG. 2A. In a state IIB, the rotor core 20 rotates 60 degrees clockwise from the state IIA, and the inner surface of the protruding portion 13 is opposite none of the teeth 21-23 of the rotor core 20.

In the state IIA where the protruding portion 13, is opposite the rotor core 20, the air gap between the rotor core 20 and the protruding portion 13 becomes small. Thus, the magnetic resistance of the motor 2 becomes small. Since the inductance is proportional to the inverse of the magnetic resistance, the inductance of the motor circuit changes in accordance with the change in the magnetic resistance. Therefore, when the magnetic resistance becomes small, the inductance of the motor circuit becomes large.

In the state IIB where the protruding portion 13 is not opposite the rotor core 20, the air gap becomes larger than the air gap in the state IIA. Thus, the magnetic resistance of the motor 2 becomes large, and the inductance of the motor circuit becomes small.

In this way, the inductance of the motor circuit depends on whether the rotor core 20 is opposite the protruding portion 13, and the inductance of the motor circuit periodically changes in accordance with the rotation of the motor 2, that is, the rotation of the rotor core 20 and the rotation shaft 16.

In a rotation process of the motor 2, there is a changing term where one brush is in contact with two adjacent commutator segments at the same time. The inductance of the motor circuit also changes in the changing term. However, the changing term is momentarily occurs while the motor 2 rotates one revolution, and the change in the inductance in the changing term is also momentary. Therefore, in the present embodiment, the changing term is not considered.

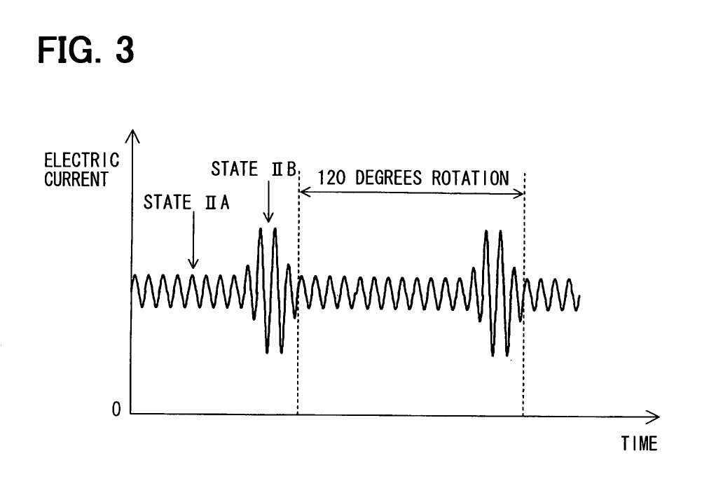

Since the inductance of the motor circuit periodically changes in accordance with the rotation of the motor 2, the amplitude of the alternating-current component of the electric current that flows in the motor 2 changes in accordance with the rotation angle as shown in FIG. 3. In the state IIA where one of the teeth 21-23 is opposite the protruding portion 13 and the inductance becomes large, the amplitude of the alternating-current component becomes small. In the state IIB where none of the teeth 21-23 is opposite the protruding portion 13, the amplitude of the alternating-current component becomes large.

Because the rotor core 20 has the three teeth 21-23, the inductance of the motor circuit changes with a period of 120 degrees. Thus, the amplitude of the alternating-current component also changes with a period of 120 degrees.

The rotation signal detecting part 4 detects the change in the amplitude of the alternating-current component included in the electric current that flows in the motor 2. That is, the rotation signal detecting part 4 detects the change in the amplitude of the alternating-current component caused by the change in the inductance. Then, the rotation signal detecting part 4 generates the rotation pulse based on the change in the amplitude of the alternating-current component.

The rotation signal detecting part 4 includes an electric current detector 24 and a signal processor 25. The electric current detector 24 is disposed on the energizing path of the electric current that flows in the motor 2, for example, on the energizing path provided between the ground side brush 19 and the ground potential. The signal processor 25 generates the rotation pulse based on the electric current detected by the electric current detector 24.

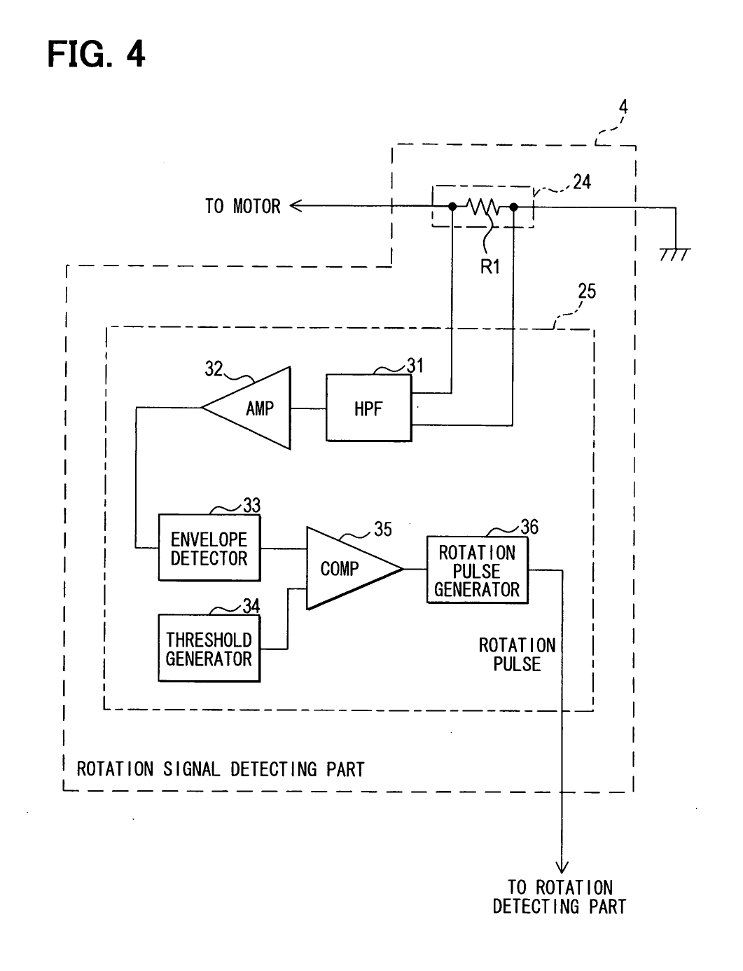

As shown in FIG. 4, the electric current detector 24 includes an electric current detecting resistor R1 inserted in the energizing path of the motor 2. Voltages at both ends of the electric current detecting resistor R1 are output to the signal processor 25 as an example of a detection signal.

The electric current detector 24 may also include a coil instead of the electric current detecting resistor R1 and voltages at both ends of the coil may be input to the signal processor 25 as another example of the detection signal. The detection signal may be any electric quantity related to the alternating-current voltage applied from the power source part 3 to the motor 2.

The signal processor 25 includes a high pass filter (HPF) 31, an amplifier (AMP) 32, an envelope detector 33, a threshold generator 34, a comparator 35, and a rotation pulse generator 36. The detection signal from the electric current detecting resistor R1 is input to the high pass filter 31. The high pass filter 31 cuts off a component of the detection signal that has a frequency lower than or equal to a predetermined frequency and includes the direct-current component. The high pass filter 31 extracts a component of the detection signal that has a frequency higher than the predetermined frequency and includes the alternating-current component and input the extracted component to the amplifier 32. Thus, in the detected electric current (detection signal), the direct-current component is removed by the high pass filter 31, and only the alternating-current component is input to the amplifier 32.

The alternating-current component in the detection signal detected by the electric current detecting resistor R1 and extracted by the high pass filter 31 is one of electric quantities relative to the alternating current in the electric current that flows in the motor 2. Because the alternating-current component in the detection signal is very weak, the alternating-current component of the detection signal is amplified by the amplifier 32.

The detection signal amplified by the amplifier 32 is input to the envelope detector 33. The envelope detector 33 includes, for example, a rectifier circuit and a low pass filter. The envelope detector 33 detects an envelope of the alternating-current component of the detection signal from the amplifier 32 and generates an envelope detection signal depending on the amplitude of the alternating-current component. In the electric current that flows in the motor 2, the alternating current is superimposed on the direct current. The amplitude of alternating-current component changes with a period of 120 degrees. Thus, the amplitude of the envelope detection signal output from the envelope detector 33 changes with a period of 120 degrees.

The envelope detection signal is input to one input terminal of the comparator 35. The threshold generator 34 generates a threshold value and inputs the threshold value to the other input terminal of the comparator 35. The threshold value is set to a value between the envelope detection signal at a time when the amplitude is small, which corresponds to state IIA, and the envelope detection signal at a time when the amplitude is large, which corresponds to state IIB. For example, the threshold value is set to an intermediate value between both of the envelope detection signals.

Thus, when the amplitude is small, the envelope detection signal from the envelope detector 33 is smaller than the threshold value of the threshold generator 34. Thus, the comparator 35 outputs a low level signal. On the other hand, when the amplitude is large, the envelope detection signal from the envelope detector 33 is larger than the threshold value. Thus, the comparator 35 outputs a high level signal.

The rotation pulse generator 36 appropriately adjusts a waveform and a level of the low level signal and the high level signal from the comparator 35 and outputs the adjusted signal as a rotation pulse depending on the rotation angle of the motor 2 to the rotation detecting part 5.

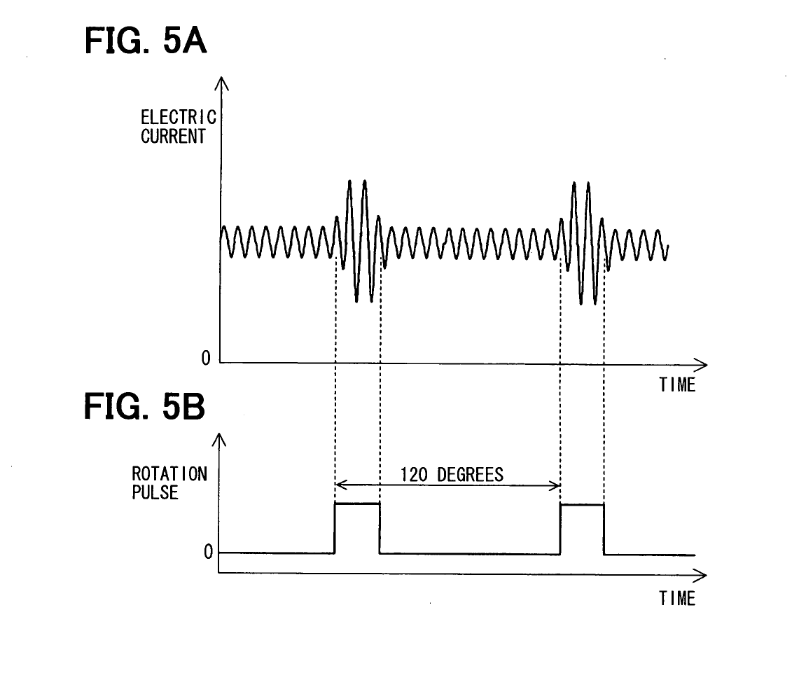

An example of the rotation pulse generated by the rotation pulse generator 36 will be described with reference to FIG. 5. FIG. 5A is a waveform diagram of the electric current that flows in the motor 2, and FIG. 5B is a waveform diagram of the rotation pulse generated by the rotation pulse generator 36. In the present example, the rotation pulse transitions from a low level to a high level when the amplitude of the alternating-current component changes from a small amplitude to a large amplitude and transitions from the high level to the low level when the amplitude of the alternating-current component changes from the large amplitude to the small amplitude. Thus, the rotation pulse generator 36 generates the rotation pulse with a period of 120 degrees.

As described above, in the signal processor 25, the detection signal detected by the electric current detecting resistor R1 is treated with various processes including cutting off a low frequency region, amplifying the alternating-current component, and detecting the envelope, and the rotation pulse generator 36 generates the rotation pulse based on the treated detection signal. Thus, the rotation pulse generator 36 can generate a rotation pulse in which an influence by a disturbance and noise is restricted. The signal processor 25 may also include a band pass filter instead of the high pass filter 31, and the band pass filter may be configured so as to pass only a predetermined band including the frequency of the alternating-current component

The rotation detecting part 5 detects the rotation angle of the motor 2, for example, by detecting rising edges of the rotation pulse from the rotation pulse generator 36. The rotation angle detected by the rotation detecting part 5 is used as a feedback signal in a control circuit (not shown) of the motor 2.

As described above, the motor 2 according to the present embodiment includes the protruding portion 13. Thus, the rotation detecting part 5 detects the rotation angle in the rotation state of the motor 2. If the rotation pulse from the rotation signal detecting part 4 is a pulse from which the rotation direction is also detectable as a motor 60 in a following fifth embodiment, the rotation detecting part 5 can also detect the rotation direction based on the rotation pulse.

As described above, in the rotation detection apparatus 1 according to the present embodiment, the alternating-current component generator 7 for detecting the rotation state is provided in addition to the direct-current power source 6 for driving the motor 2. The alternating-current voltage from the alternating-current component generator 7 is superimposed on the direct-current voltage from the direct-current power source 6 and is applied to the motor 2. Thus, the electric current including the alternating-current component flows in the motor circuit in the motor 2.

Because the protruding portion 13 having a soft magnetic property is provided on the inner surface of the housing 10, the inductance of the motor circuit periodically changes in accordance with the rotation of the motor 2. Thus, the alternating-current component of the electric current that flows in the motor circuit periodically changes in accordance with the change in the inductance.

The signal processor 25 extracts only the alternating-current component from the electric current that flows in the motor 2 and generates the rotation pulse in accordance with the change in the amplitude of the alternating-current component. The rotation detecting part 5 detects the rotation state (in the present embodiment, the rotation angle) of the motor 2 based on the rotation pulse.

The alternating-current voltage from the alternating-current component generator 7 is applied for detecting the rotation state of the motor 2 and does not influence the torque of the motor 2. Thus, a constant alternating-current voltage can be applied to the motor 2 regardless of an operating state of the motor 2 (for example, an acceleration state, a deceleration state, a constant-speed state, and a stop state), and the rotation state can be constantly detected based on the change in the amplitude of the alternating-current component regardless of the operating state of the motor 2.

Even when the application of the direct-current voltage to the motor 2 is stopped, the application of the alternating-current voltage can be kept. Thus, the rotation state can be detected with accuracy even when the motor 2 is decelerated or stopped. Furthermore, even if the motor 2 rotates a predetermined angle due to an external force while the application of the direct-current voltage is stopped, the rotation of the motor 2 can be certainly detected by keeping the application of the alternating-current voltage.

Therefore, when the operation for stopping the rotation of the motor 2 is performed by stopping the application of the direct-current voltage from the direct-current power source 6 to the motor 2, the application of the alternating-current voltage can be kept. When the application of the direct-current voltage is stopped, an electric current that flows in the motor 2 is a superimposed current of an electric current caused by induced electromotive force and the alternating current due to the alternating-current voltage generated by the alternating-current component generator 7.

The electric current caused by the induced electromotive force becomes smaller as the rotation speed of the motor 2 becomes lower. The electric current caused by the induced electromotive force gradually becomes smaller, and the electric current becomes zero when the motor 2 is stopped. Because the alternating current is kept flowing for detecting the rotation state, the change in the amplitude of the alternating-current component depending on the rotation state can be detected regardless of the rotation speed of the motor 2. Thus, the rotation angle of the motor 2 can be detected regardless of the rotation speed of the motor 2.

The rotation detecting apparatus 1 according to the present embodiment detects the rotation angle of the motor 2 based on the rotation pulse. The rotation detecting apparatus 1 may also detect the rotation speed of the motor 2 based on intervals of the rotation pulses (for example, intervals of the rising edges).

Thus, the rotation detecting apparatus 1 according to the present embodiment can detect the rotation state of the motor 2 with a high degree of accuracy regardless of the rotation speed without providing a sensor such as a rotary encoder and generating a torque fluctuation.

Furthermore, only by providing the protruding portion 13 on the inner surface of the housing 10, the inductance the motor circuit between the brushes 18 and 19 can be certainly changed in accordance with the rotation of the motor 2. Thus, the rotation state can be certainly detected based on the change in the inductance and eventually the change in the amplitude of the alternating-current component while restricting increase in the dimension and the cost of the motor 2 and eventually increase in the dimension and the cost of the rotation detecting apparatus 1.

Furthermore, in the present embodiment, the change in the inductance of the motor circuit caused by the rotation of the motor 2 is detected as the change in the amplitude of the alternating-current component of the electric current that flows in the motor 2. The change of the amplitude of the alternating-current component is detected by the comparator 35 after the detection signal is treated by the high pass filter 31, the amplifier 32, and the envelope detector 33. Thus, even through the rotation detecting apparatus 1 has a simple structure, the rotation detecting apparatus 1 can restrict the influence of a disturbance and noise and can detect the change in the amplitude with accuracy. As a result, the rotation detecting apparatus 1 can detect the rotation state of the motor 2 with accuracy.

The protruding portion 13 is provided at a predetermined distance from each of the magnets 11 and 12. Thus, the torque of the motor 2 does not become weak due to leakage flux.

In the method disclosed in JP-A-2003-111465, because the resistor is coupled with the phase coil and the change in the direct current is detected, the detection accuracy may decrease due to aged deterioration of the brushes and the commutator. On the other hand, the rotation detecting apparatus 1 according to the present embodiment detects the rotation angle based on the change in the amplitude of the alternating-current component which depends on the inductance of the motor circuit. Thus, the rotation detection apparatus 1 according to the present embodiment can restrict the influence of aged deterioration of the brushes 18, 19 and the commutator 17.

The power source part 3 can function as a power source part, the alternating-current component generator 7 can function as an alternating current power source, the coupling capacitor C1 can function as a superimposing portion, and the electric current detector 24 can function as an energization detecting part. The signal processor 25 and the rotation detecting part 5 can function as a rotation state detecting part.

In the rotation detecting apparatus 1 according to the present embodiment, the motor 2 has the protruding portion 13 at one of the two clearance regions between the magnets 11 and 12. As long as a motor can cause a periodical change in an inductance in accordance with a rotation of the motor, the motor can have vicarious configurations. Other examples of a motor in which an inductance periodically changes in accordance with a rotation of the motor will be described in second to eleventh embodiments.

### Second Embodiment

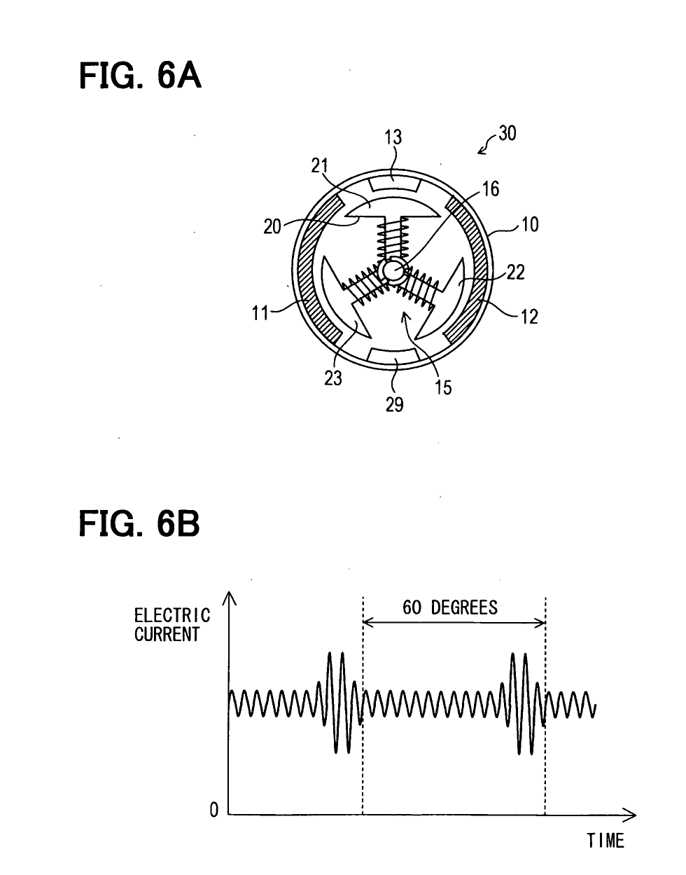

A motor 30 according to a second embodiment of the present invention will be described with reference to FIG. 6A and FIG. 6B.

As shown in FIG. 6A, the motor 30 includes protruding portions 13 and 29 made of a soft magnetic material. The protruding portions 13 and 29 are provided on the inner surface of the housing 10. The protruding portion 13 is provided between one of two clearance regions between the magnets 11 and 12, and the protruding portion 29 is provided between the other one of the two clearance regions.

The protruding portions 13 and 29 are opposite each other in the radial direction of the housing 10 and are apart from each other at 180 degrees. In the circumferential direction of the housing 10, each of the protruding portions 13 and 29 is apart from both of the magnets 11 and 12 so that each of the protruding portions 13 and 29 is not in contact with the magnets 11 and 12.

That is, the motor 30 includes the protruding portion 29 in addition to the protruding portion 13 provided in the motor 2 according to the first embodiment. Other components of the motor 30 are similar to those components of the motor 2. Thus, the components of the motor 30 have the same reference numbers as the similar components of the motor 2 according to the first embodiment, and description about those components will be omitted.

As shown in FIG. 6A, the motor 30 according to the present embodiment includes the two protruding portions 13 and 29 being opposite each other. Thus, the inductance of a motor circuit changes with a period of 60 degrees.

When the power source voltage including the alternating-current component is applied from the power source part 3, the amplitude of the alternating-current component in the electric current that flows in the motor 30 changes with a period of 60 degrees as shown in FIG. 6B. That is, the number of change in the amplitude caused during one revolution of the motor 30 becomes double compared with the first embodiment. Therefore, the signal processor 25 outputs a rotation pulse with a period of 60 degrees, and the rotation detecting part 5 detects a rotation state (rotation angle) of the motor 30 based on the rotation pulse.

In the motor 30 according to the present embodiment, since the number of the change in the amplitude of the alternating-current component caused during one revolution of the motor 30 can be double compared with the motor 2 according to the first embodiment, the detection accuracy can be improved.

### Third Embodiment

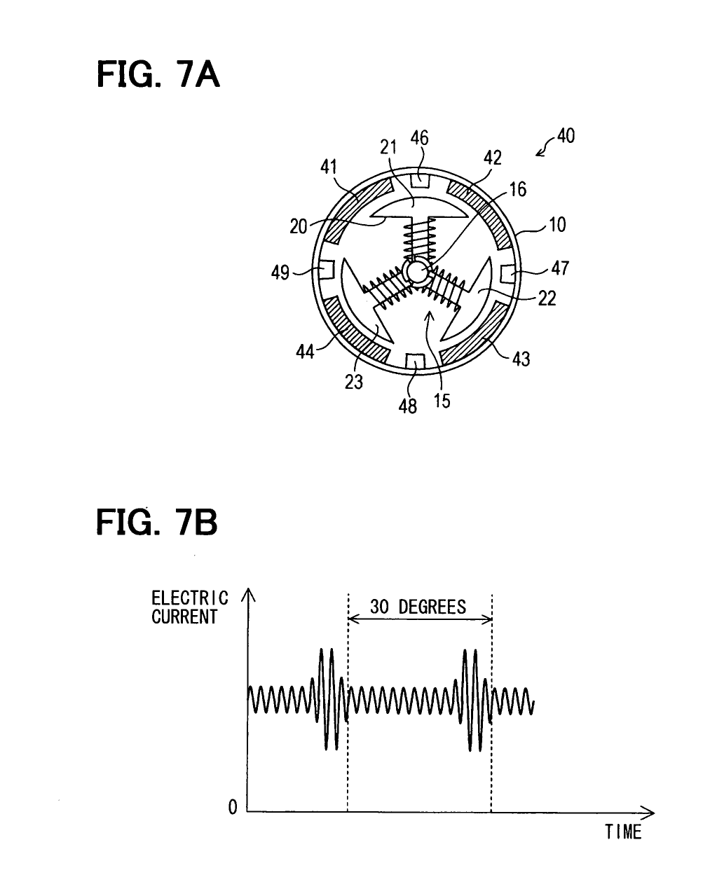

A motor 40 according to a third embodiment of the present invention will be described with reference to FIG. 7A and FIG. 7B.

As shown in FIG. 7A, the motor 40 includes four magnets 41-44 for generating magnetic field. The magnets 41-44 are fixed on the inner surface of the housing 10. The magnets 41-44 are apart from each other in the circumferential direction of the housing 10. Thus, on the inner surface of the housing 10, there are four clearance regions between the magnets 41-44 in the circumferential direction. The four clearance regions are arranged at intervals of about 90 degrees. Therefore, two of the clearance regions are opposite each other in the radial direction of the housing 10.

The motor 40 includes four protruding portions 46-49 made of a soft magnetic material. The four protruding portions 46-49 are provided at the four clearance regions, respectively, and protrude from the inner surface of the housing 10 radially inward.

The four protruding portions 46-49 are arranged at intervals of 90 degrees in the circumferential direction. Each of the protruding portions 46-49 is apart from the four magnets 41-44 so as not to be in contact with the four magnets 41-44.

The motor 40 according to the present embodiment includes the four magnets 41-44 for generating the magnetic field and four protruding portions 46-49. Other components of the motor 40 are similar to those components of the motor 2 according to the first embodiment. Thus, the components of the motor 40 have the same reference numbers as the similar components of the motor 2 according to the first embodiment, and description about those components will be omitted.

As shown in FIG. 7A, the motor 40 according to the present embodiment includes the four protruding portions 46-49 arranged at intervals of 90 degrees in the circumferential direction. Thus, in accordance with the rotation of the motor 40, the inductance of a motor circuit changes with a period of 30 degrees.

When the power source voltage including the alternating-current component is applied from the power source part 3, amplitude of the alternating-current component in the electric current that flows in the motor 40 changes with a period of 30 degrees. That is, the number of change in the amplitude caused during one revolution of the motor 40 becomes four times compared with the first embodiment. Therefore, the signal processor 25 outputs a rotation pulse with a period of 30 degrees, and the rotation detecting part 5 detects a rotation state (rotation angle) of the motor 40 based on the rotation pulse.

In the motor 40 according to the present embodiment, since the number of the change in the amplitude of the alternating-current component caused during one revolution of the motor 40 can be four times compared with the motor 2 according to the first embodiment, the detection accuracy can be improved.

### Fourth Embodiment

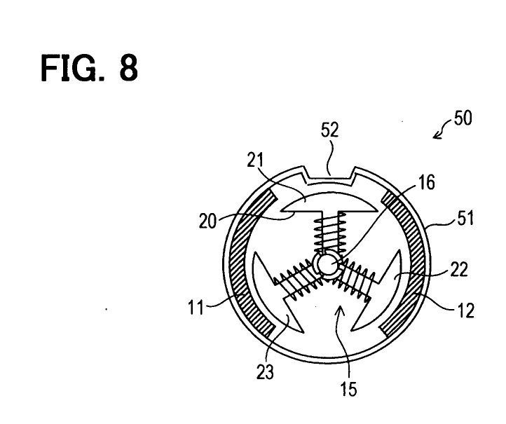

A motor 50 according to a fourth embodiment of the present invention will be described with reference to FIG. 8.

The motor 50 includes a housing 51. The housing 51 has a protruding portion 52 that protrudes radially inward. The protruding portion 52 can function similarly to the protruding portion 13 according to the first embodiment. The protruding portion 52 can be formed by protruding a predetermined region of the housing 51 by cutting and bending.

That is, in the motor 50 according to the present embodiment, a protruding portion is not provided independently of the housing 10 as the above-described embodiments but a part of the housing 51 is formed into the protruding portion 52. The protruding portion 52 can function similarly to the protruding portions in the above-described embodiments.

The motor 50 according to the present embodiment is similar to the motor 2 according to the first embodiment except that the protruding portion 52 is formed by processing the predetermined region of the housing 51. Thus, components of the motor 50 have the same reference numbers as similar components of the motor 2 according to the first embodiment, and description about those components will be omitted.

Although a forming method of the protruding portion 52 is different from the protruding portion 13 of the first embodiment, a magnetic function of the protruding portion 52 is similar to a magnetic function of the protruding portion 13. Thus, from a standpoint of magnetism, the motor 50 according to the present embodiment is equivalent to the motor 2 according to the first embodiment.

Thus, the motor 50 can have similar effects with the motor 2 according to the first embodiment. Furthermore, because the protruding portion 52 is formed by processing the predetermined region of the housing 51, the number of processes for forming the protruding portion 52, and eventually the number of processes for forming the motor 50 can be reduced.

### Fifth Embodiment

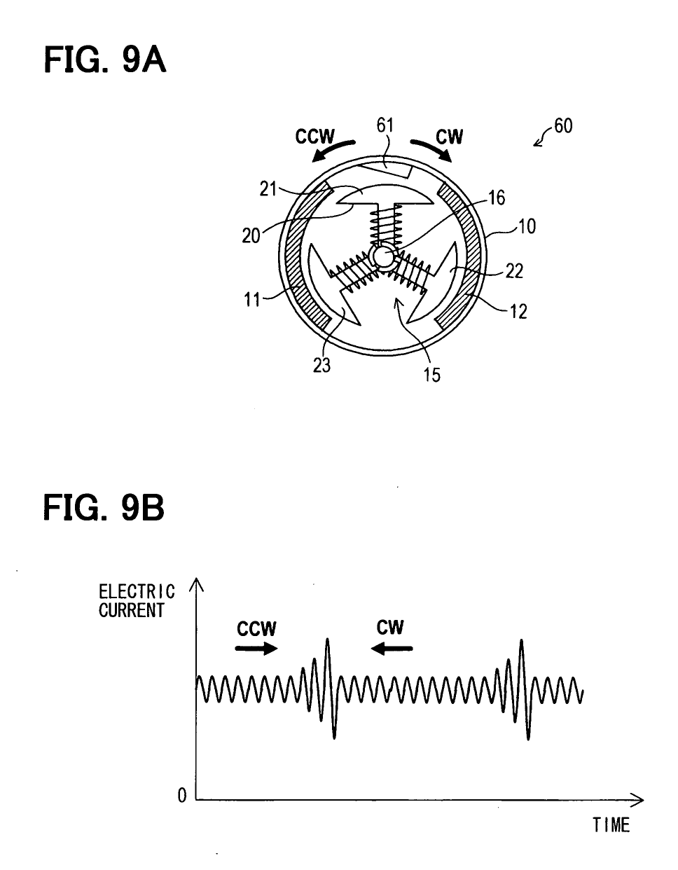

A motor 60 according to a fifth embodiment of the present invention will be described with reference to FIG. 9A and FIG. 9B.

The motor 60 includes an inclined protruding portion 61 made of a soft magnetic material. The inclined protruding portion 61 is provided at one of the two clearance regions between the magnets 11 and 12 on the inner surface of the housing 10. The position and the material of the inclined protruding portion 61 are similar to those of the protruding portion 13 according to the first embodiment. The inclined protruding portion 61 is different from protruding portion 13 only in the shape.

That is, the motor 60 according to the present embodiment is similar to the motor 2 according to the first embodiment except that the motor 60 includes the inclined protruding portion 61 instead of the protruding portion 13. Thus, components of the motor 60 have the same reference numbers as similar components of the motor 2 according to the first embodiment, and description about those components will be omitted.

The inclined protruding portion 61 has a surface being opposite the rotor core 20, and the surface is inclined with respect to the inner surface of the housing 10. In other words, a thickness of the inclined protruding portion and a gap between the inclined protruding portion and the rotor core 20 continuously change in the circumferential direction of the housing 10.

While the motor 60 is rotating, an inductance of a motor circuit changes depending on a rotation direction of the motor 60. Because the change in the inductance depends on the rotation direction, a change in the amplitude of the alternating-current component also depends on the rotation direction.

Thus, when the power source voltage including the alternating-current component is applied from the power source part 3 to the motor 60, a change pattern of the amplitude of the alternating-current component that is caused when the motor 60 rotates clockwise (CW) and a change pattern of the amplitude of the alternating-current component that is cause when the motor 60 rotates counterclockwise (CCW) are different from each other.

In a case where the motor 60 rotates clockwise (CW), when one of the teeth 21-23 approaches the inclined protruding portion 61, the gap between the tooth and the inclined protruding portion 61 gradually decreases. Thus, a magnetic resistance of the motor 60 gradually decreases, the inductance of the motor circuit gradually increases, and the amplitude of the alternating-current component gradually decreases. Then, when the tooth moves away from the inclined protruding portion 61, the gap suddenly increases. Thus, the magnetic resistance suddenly increases, the inductance suddenly decreases, and the amplitude of the alternating-current component suddenly increases as shown in FIG. 6B.

In contrast, in a case where the motor 60 rotates counterclockwise (CCW), when one of the teeth 21-23 approaches the inclined protruding portion 61, the gap between the tooth and the inclined protruding portion 61 suddenly decreases. Thus, the magnetic resistance of the motor 60 suddenly decreases, the inductance of the motor circuit suddenly increases, and the amplitude of the alternating-current component suddenly decreases. Then, when the tooth moves away from the inclined protruding portion 61, the gap gradually increases. Thus, the magnetic resistance gradually increases, the inductance gradually decreases, and the amplitude of the alternating-current component gradually increases as shown in FIG. 9B.

In this way, the change pattern of the amplitude of the alternating-current component depends on the rotation direction. Thus, the rotation angle can be detected in a manner similar to the above-described embodiments, and further the rotation direction can be detected based on the change pattern.

In the signal processor 25 shown in FIG. 4, the comparator 35 compares the envelope detection signal from the envelope detector 33 and the threshold value from the threshold generator 34, and the rotation pulse generator 36 generates the rotation pulse based on the comparison result of the comparator 35. Thus, if the signal processor 25 shown in FIG. 4 is used in the present embodiment, at least the rotation angle can be detected.

In order to detect the rotation direction as well as the rotation angle, a part of the configuration of the signal processor 25 needs to be changed so that a signal corresponding to a change pattern of the envelope detection signal is output independently of or as a part of the rotation pulse.

A signal corresponding to the change pattern of the envelope detection signal can be detected by various methods such as, for example, by differentiating the envelope detection signal by passing through a differential circuit. When the signal processor 25 outputs the signal corresponding to the change pattern of the amplitude of the envelope detection signal, the rotation detecting part 5 can detect the rotation direction as well as the rotation angle.

As described above, because the motor 60 according to the present embodiment includes the inclined protruding portion 61, the change pattern of the amplitude of the alternating-current component caused by the rotation of the motor 60 depends on the rotation direction. Thus, the rotation direction of the motor 60 can be detected based on the change pattern. Furthermore, because the rotation direction can be detected, a detection result of the rotation angle can be compensated based on a detection result of the rotation direction. Thus, even when the rotation direction of the motor 60 changes, the rotation angle can be detected with accuracy based on the detection result of the rotation direction.

In the example shown in FIG. 9A, the surface of the inclined protruding portion being opposite the rotor core 20 is inclined plane so that the gap between the rotor core 20 and the inclined protruding portion 61 changes linearly. The inclined protruding portion 61 may also have various shapes including an inclined curved surface and an inclines stepped surface.

### Sixth Embodiment

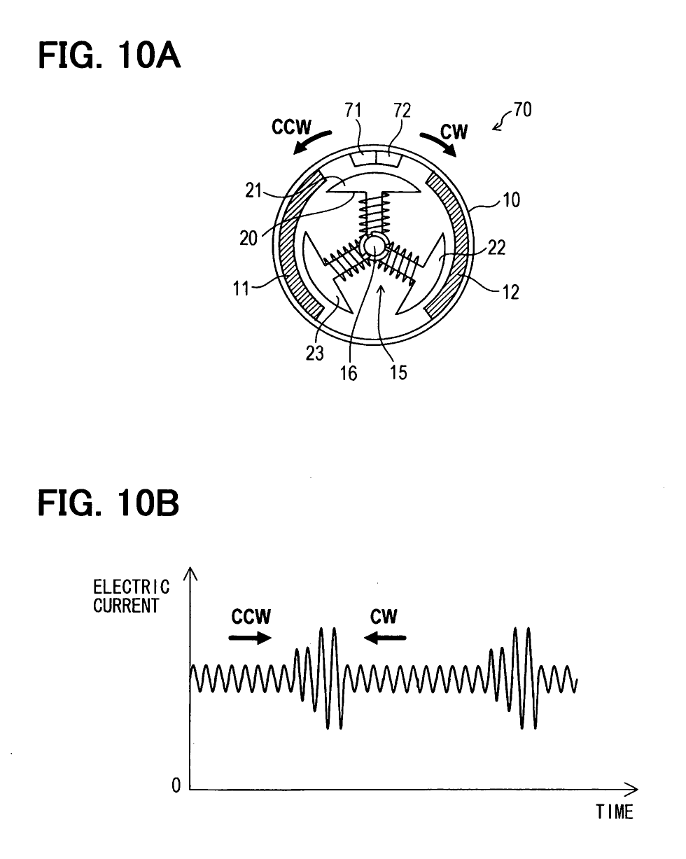

A motor 70 according to a seventh embodiment of the present embodiment will be described with reference to FIG. 10A and FIG. 10B.

As shown in FIG. 10A, the motor 70 includes a first protruding element 71 and a second protruding element 72 disposed on the inner surface of the housing 10. The first protruding element 71 and the second protruding element 72 are disposed in one of two clearance regions between the magnets 11 and 12. The first protruding element 71 is made of a soft magnetic material having a first magnetic permeability. The second protruding element 72 is disposed next to the first protruding element 71 in the clockwise direction. The second protruding element 72 is made of a soft magnetic material having a second magnetic permeability that is larger than the first magnetic permeability. The first protruding element 71 and the second protruding element 72 have the same length in the circumferential direction and the same width in the radial direction.

The motor 70 according to the present embodiment is similar to the motor 2 according to the first embodiment except that the motor 70 includes the first protruding element 71 and the second protruding element 72 instead of the protruding portion 13. Thus, components of the motor 70 have the same reference numbers as similar components of the motor 2 according to the first embodiment, and description about those components will be omitted.

In the motor 70 according to the present embodiment, the first protruding element 71 and the second protruding element 72 disposed adjacent to each other have different magnetic permeabilities. Thus, a change pattern of the amplitude of the alternating-current component caused when the motor 70 rotates clockwise (CW) and a change pattern of the amplitude of the alternating-current component caused when the motor 70 rotates counterclockwise (CCW) are different from each other.

In a case where the motor 70 rotates clockwise (CW), when one of the teeth 21-23 approaches the first protruding element 71 and the second protruding element 72, the tooth firstly approaches the first protruding element 71 having the first magnetic permeability, and then the tooth approaches the second protruding element 72 having the second magnetic permeability larger than the first permeability. Thus, the magnetic resistance decreases in stages, the inductance of the motor circuit increases in stages, and the amplitude of the alternating-current component decreases in stages. Then, when the tooth passes the first protruding element 71 and the second protruding element 72 and moves away from the second protruding element 72, the magnetic resistance suddenly increases. Thus, the inductance suddenly decreases and the amplitude of the alternating-current component suddenly increases as shown in FIG. 10B.

In a case where the motor 70 rotates counterclockwise, when one of the teeth 21-23 approaches the first protruding element 71 and the second protruding element 72, the tooth firstly approaches the second protruding element 72 having the second magnetic permeability, and then the tooth approaches the first protruding element 71 having the first magnetic permeability smaller than the second permeability. Thus, the magnetic resistance of the motor 70 suddenly decreases, the inductance of the motor circuit suddenly increases, and the amplitude of the alternating-current component suddenly decreases. Then, when the tooth passes the second protruding element 72 and the first protruding element 71 and moves away from the first protruding element 71, the magnetic resistance increases in stages. Thus, the inductance decreases in stages and the amplitude of the alternating-current component increases in stages as shown in FIG. 10B.

In this way, also in the motor 70 according to the present embodiment, the change pattern of the amplitude of the alternating-current component depends on the rotation direction. Thus, the rotation direction can be detected in a manner similar to the motor 60 according to the fifth embodiment, and the motor 70 can have similar effects with the motor 60 according to the fifth embodiment.

In the example shown in FIG. 10A, the first protruding element 71 and the second protruding element 72 are adjacent to each other. The first protruding portion 71 and the second protruding portion 72 may also be apart from each other. Alternatively, the motor 70 may also includes three or more protruding portions having different magnetic permeabilities at one of the clearance regions between the magnets 11 and 12.

### Seventh Embodiment

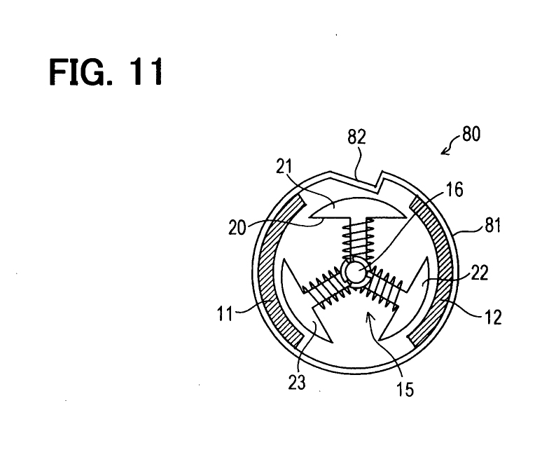

A motor 80 according to a seventh embodiment of the present invention will be described with reference to FIG. 11.

The motor 80 includes a housing 81. The housing 81 has an inclined protruding portion 82 that protrudes radially inward. The protruding portion 82 can function similarly to the inclined protruding portion 61 according to the fifth embodiment. The inclined protruding portion 82 can be formed by protruding a predetermined region of the housing 81 by cutting and bending. That is, in the motor 80 according to the present embodiment, an inclined protruding portion is not provided independently of the housing 10 as the fifth embodiments but a part of the housing 81 is formed into the inclined protruding portion 82. The inclined protruding portion 82 can function similarly to the inclined protruding portion 61 of the fifth embodiment.

Although a forming method of the inclined protruding portion 82 is different from the inclined protruding portion 61 of the fifth embodiment, a magnetic function of the inclined protruding portion 82 is similar to a magnetic function of the inclined protruding portion 61. Thus, from a standpoint of magnetism, the motor 80 according to the present embodiment is equivalent to the motor 60 according to the fifth embodiment.

Thus, the motor 80 can have similar effects with the motor 60 according to the fifth embodiment. Furthermore, because the inclined protruding portion 82 is formed by processing the predetermined region of the housing 81, the number of processes for forming the inclined protruding portion 82, and eventually the number of processes for forming the motor 80 can be reduced.

### Eighth Embodiment

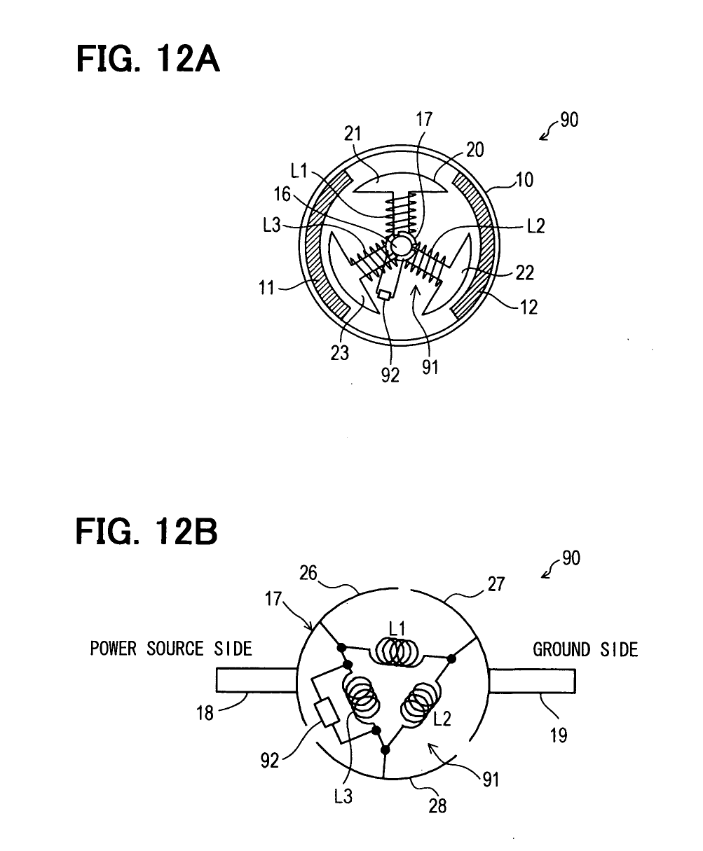

A motor 90 according to an eighth embodiment of the present invention will be described with reference to FIG. 12A and FIG. 12B.

As shown in FIG. 12A, the motor 90 includes an armature coil 91 and an inductance element 92. The armature coil 91 includes a first phase coil L1, a second phase coil L2, and a third phase coil L3. The first phase coil L1, the second phase coil L2, and the third phase coil L3 are wound to the first tooth 21, the second tooth 22, and the third tooth 23 of the rotor core 20, respectively. The inductance element 92 is coupled in parallel with one of the phase coils L1-L3 in the armature coil 91. Except that the motor 90 includes the inductance element 92, the motor 90 is similar to the motor 2 according to the first embodiment. Thus, components of the motor 90 have the same reference numbers as similar components of the motor 2 according to the first embodiment, and description about those components will be omitted.

The inductance element 92 is coupled in parallel with, for example, the third phase coil L3 in the three phase coils L1-L3 in the armature coil 91, as shown in FIG. 12B.

The inductance element 92 has a predetermined inductance. For example, the inductance element 92 has an inductance much smaller than the inductance of each of the phase coils L1-L3.

Thus, the whole inductance of a third phase including the third phase coil L3 and the inductance element 92 is a parallel combined inductance of the third phase coil L3 and the inductance element 92 and is smaller than the inductance of each of a first phase including the first phase coil L1 and a second phase including the second phase coil L2. Thus, the inductance between the brushes 18 and 19 periodically changes with the rotation of the motor 90.

While the motor 90 rotates 180 degrees, a connection state in the motor 90, that is, a motor circuit provided between the brushes 18 and 19 becomes three states XIIIA, XIIIC, and XIIIE.

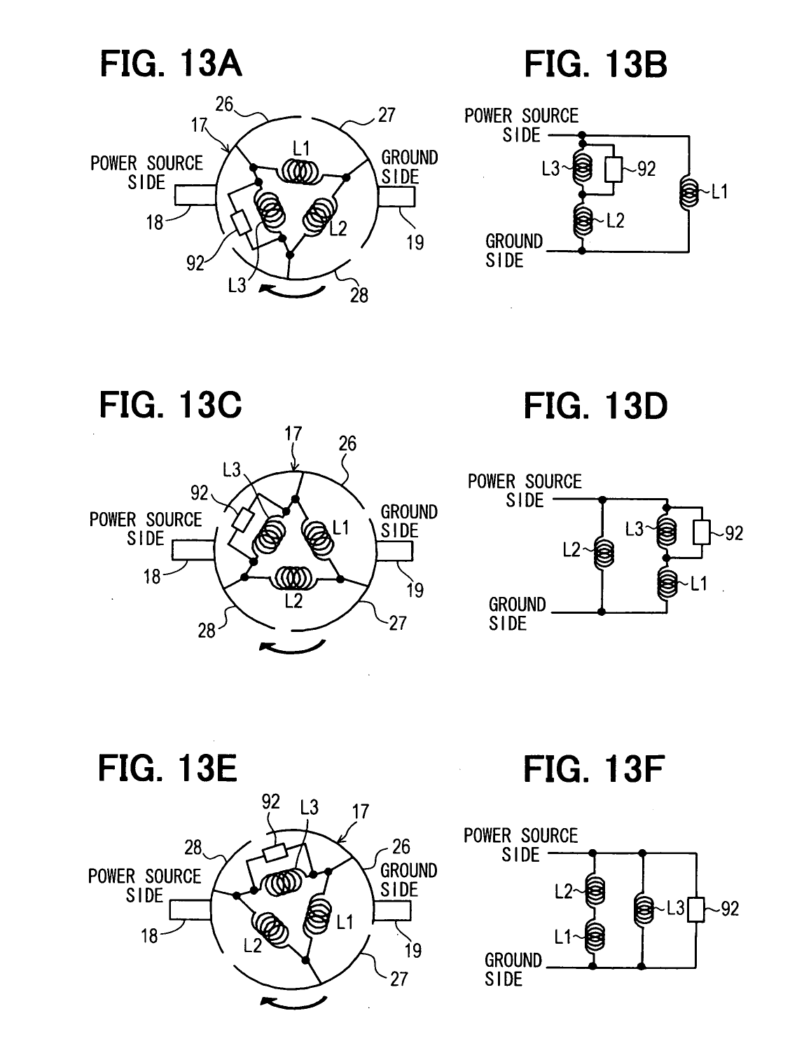

In the state XIIIA, as shown in FIG. 13A, the first commutator segment 26 is in contact with the power source side brush 18 and the second commutator segment 27 is in contact with the ground side brush 19. When the motor 90 is in the state XIIIA, the motor circuit provided between the brushes 18 and 19 becomes a circuit shown in FIG. 13B.

The state XIIIC is a state where the motor 90 rotates about 60 degrees clockwise from the state XIIIA. In the state XIIIC, the commutator segment being in contact with the power source side brush 18 changes from the first commutator segment 26 to the third commutator segment 28. The ground side brush 19 is in contact with the second commutator segment 27. When the motor 90 is in the state XIIIC, the motor circuit provided between the brushes 18 and 19 becomes a circuit shown in FIG. 13D.

The state XIIIE is a state where the motor 90 rotates about 60 degrees clockwise from the state XIIIC. The commutator segment being in contact with the ground side brush 19 changes from the second commutator segment 27 to the first commutator segment 26. The power source side brush 18 is in contact with the third commutator segment 28.

The inductance of the whole motor circuit in the state XIIIA and the inductance of the whole motor circuit in the state XIIIC are the same as shown in FIG. 13B and FIG. 13D. In other words, if the inductance of the whole motor circuit in the state XIIIA is set to an inductance La, even when the motor 90 rotates about 60 degrees clockwise from the state XIIIA and the state of the motor 90 becomes the state XIIIC, the inductance of the whole motor circuit remain the inductance La.

However, when the motor 90 further rotates clockwise and the state of the motor 90 becomes the state XIIIE, the inductance of the whole motor circuit becomes an inductance Lb that is smaller than the inductance La. A ratio of the inductance La to the inductance Lb becomes large when the inductance of the inductance element 92 is set to be smaller than inductance of each of the phase coils L1-L3.

While the motor 90 rotates 180 degrees, the commutator segments coming in contact with the brushes 18 and 19 change three times, and thereby the state of the motor circuit between the brushes 18 and 19 changes among the state XIIIA, XIIIC, and XIIIE. Because the inductance of the whole motor circuit in the state XIIIA and the state XIIIB are the same, the change in the inductance caused while the motor 90 rotates 180 degrees is twice. That is, the inductance of the motor circuit changes between the inductance La and the inductance Lb. The change in the inductance of the motor circuit can be detected as a change in the amplitude of the alternating-current component of the electric current that flows in the motor 90.

When the motor 90 further rotates from the state XIIIE, the commutator segment being contact with the power source brush 18 changes from the third commutator segment 28 to the second commutator segment 27. The ground side brush 19 is in contact with the first commutator segment 26. The present state is a state where the brushes 18 and 19 are switched in the state XIIIA, and the inductance of the whole motor circuit is same as the state XIIIA. The present state is called a state XIIIa.

When the motor 90 further rotates from the state XIIIa, the commutator segment being in contact with the ground side brush 19 changes from the first commutator segment 26 to the third commutator segment 28. The power source side brush 18 is in contact with the second commutator segment 27. The present state is a state where the brushes 18 and 19 are switched in the state XIIIC, and the inductance of the whole motor circuit is same as the state XIIIC. The present state is called a state XIIIc.

When the motor 90 further rotates from the state XIIIc, the commutator segment being contact with the power source side brush 18 changes from the second commutator segment 27 to the first commutator segment 26. The ground side brush 19 is in contact with the third commutator segment 28. The present state is a state where the brushes 18 and 19 are switched in the state XIIIE, and the inductance of the whole motor circuit is same as the state XIIIE. The present state is called a state XIIIe.

When the motor 90 further rotates from the state XIIIe, the motor 90 returns to the state XIIIA. Then, the state of the motor 90 changes to the states XIIIC, XIIIE, XIIIa, XIIIc, and XIIIe in this order.

In other words, while the motor 90 rotates one revolution, the state of the motor circuit changes to the six states XIIIA, XIIIC, XIIIE, XIIIa, XIIIc, and XIIIe in this order with an interval of 60 degrees. In the states XIIIA, XIIIC, XIIIa, and XIIIc, the inductance of the motor circuit is the inductance La. In the states XIIIE and XIIIe, the inductance of the motor circuit is the inductance Lb that is smaller than the inductance La.

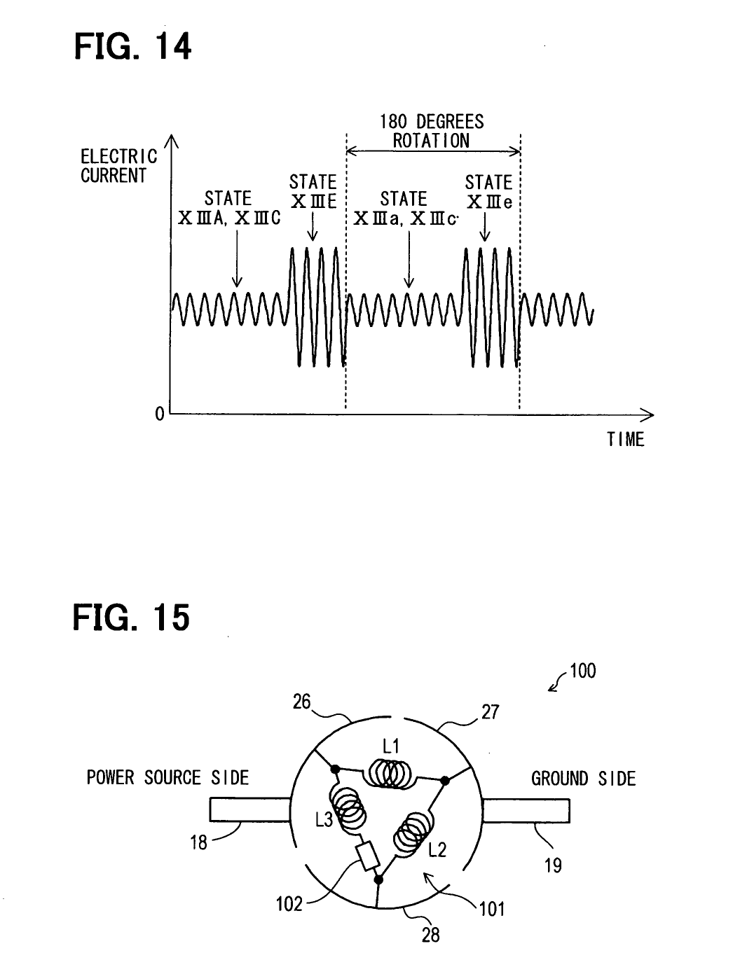

Thus, as shown in FIG. 14, the amplitude of the alternating-current component becomes small when the motor 90 is in the state XIIIA, XIIIC, XIIIa, or XIIIc, and the amplitude of the alternating-current component becomes large when the motor 90 is in the state XIIIE or XIIIe. The rotation state (in the present embodiment, the rotation angle) of the motor 90 can be detected by detecting the alternating-current component of the electric current that flows in the motor 2 by the electric current detector 24, and outputting a rotation pulse from the signal processor 25 based on the change in the amplitude of the alternating-current component included in the detection signal.

In the motor 90 according to the present embodiment, the inductance of the motor circuit can certainly be changed with the rotation of the motor 90 by coupling the inductance element 92 in parallel with one of the phase coils L1-L3 in the armature coil 91. Thus, the rotation state (rotation angle) of the motor 90 can certainly be detected based on the change in the inductance and eventually the change in the amplitude of the alternating-current component.

### Ninth Embodiment

A motor 100 according to a ninth embodiment of the present invention will be described with reference to FIG. 15.

The motor 100 includes an armature coil 101 and an inductance element 102. The armature coil 101 includes a first phase coil L1, a second phase coil L2, and a third phase coil L3. The inductance element 102 is coupled in series with the third phase coil L3. The other components of the motor 100 are similar to those components of the motor 90 according to the eighth embodiment.

Thus, the whole inductance of a third phase including the third phase coil L3 and the inductance element 102 is a series combined inductance of the third phase coil L3 and the inductance element 102 and is larger than the inductance of each of a first phase including the first phase coil L1 and a second phase including the second phase coil L2. Thus, the inductance between the brushes 18 and 19 periodically changes with the rotation of the motor 100.

When the motor 100 is in a state where the first commutator segment 26 is in contact with the power source side brush 18 and the second commutator segment 27 is in contact with the ground side brush 19 as shown in FIG. 15, the inductance between the brushes 18 and 19 is set to an inductance Lc. Even when the motor 100 rotates a predetermined angle clockwise, the third commutator segment 28 is in contact with the power source side brush 18, and the second commutator segment 27 is in contact with the ground side brush 19, the inductance between the brushes 18 and 19 remains the inductance Lc.

However, when the motor 100 further rotates clockwise, the third commutator segment 28 is in contact with the power source side brush 18, and the first commutator segment 26 is in contact with the ground side brush 19, the inductance between the brushes 18 and 19 becomes an inductance Ld that is larger than the inductance Lc.

That is, in a manner similar to the motor 90 according to the eighth embodiment, while the motor 100 rotates 180 degrees and the connection state of the brushes 18 and 19 and the commutator segments 26-28 changes three times, the inductance between the brushes 18 and 19 changes due to the inductance element 102.

Thus, in the motor 100 according to the present embodiment, the inductance of the motor circuit can certainly be changed with the rotation of the motor 100 by coupling the inductance element 102 in series with one of the phase coils L1-L3 in the armature coil 101. Thus, the rotation state (rotation angle) of the motor 100 can certainly be detected based on the change in the inductance, and eventually the change in the amplitude of the alternating-current component.

### Tenth Embodiment

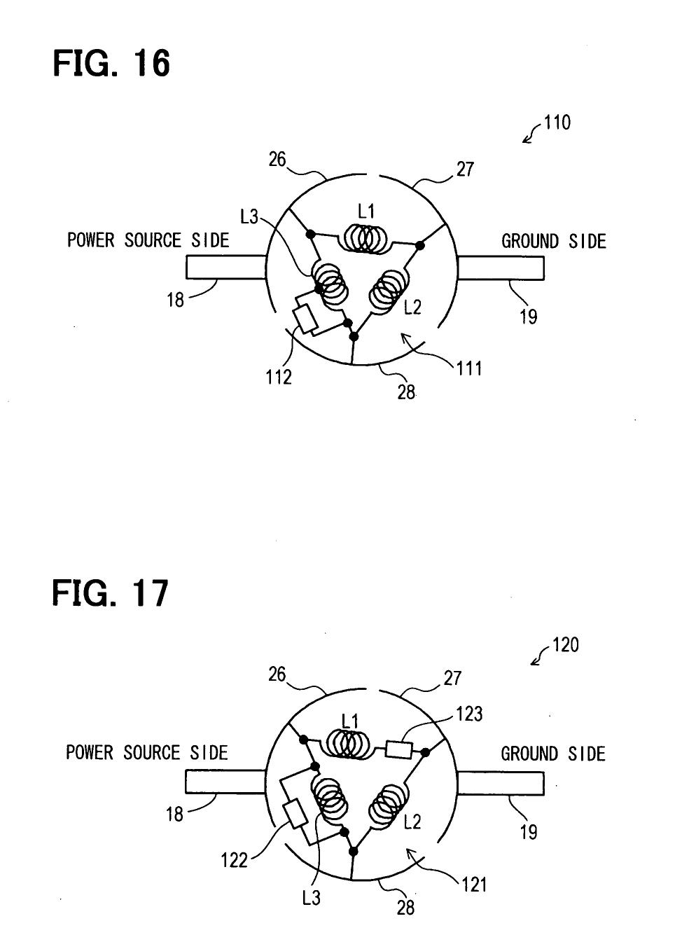

A motor 110 according to a tenth embodiment of the present invention will be described with reference to FIG. 16.

As shown in FIG. 16, the motor 110 includes an armature coil 111 and an inductance element 112. The armature coil 111 includes a first phase coil L1, a second phase coil L2, and a third phase coil L3. The inductance element 112 is coupled in parallel with a part of the third phase coil L3. The other components of the motor 110 are similar to those components of the motor 90 according to the eighth embodiment.

The whole inductance of a third phase including the third phase coil L3 and the inductance element 112 is smaller than the inductance of each of a first phase including the first phase coil L1 and a second phase including the second phase coil L2. Thus, the motor 110 can have similar effects with the motor 90 according to the eighth embodiment.

### Eleventh Embodiment

A motor 120 according to an eleventh embodiment of the present invention will be described with reference to FIG. 17.

The motor 120 includes an armature coil 121 and inductance elements 122 and 123. The armature coil 121 includes a first phase coil L1, a second phase coil L2, and a third phase coil L3. The inductance element 122 is coupled in parallel with the third phase coil L3. The inductance element 123 is coupled in series with the first phase coil L1. Thus, an inductance of each phase is different from each other. A first phase in which the first phase coil L1 and the inductance element 123 are coupled in series has the largest inductance. A third phase in which the third phase coil L3 and the inductance element 122 are coupled in parallel has the smallest inductance. A second phase including the second phase coil has an inductance between the inductance of the first phase and the inductance of the third phase.

Thus, while the motor 120 rotates 180 degrees, each time the commutator segment being in contact with each of the brushes 18 and 19 changes, the inductance of the motor circuit changes to a different value.

When the motor 120 is in a state where the brushes 18 and 19 and the commutator 17 are arranged at positions shown in FIG. 17, that is, when the first commutator segment 26 is in contact with the power source side brush 18, and the second commutator segment 27 is in contact with the ground side brush 19, the inductance between the brushes 18 and 19 is expressed by an inductance Le. When the motor 120 rotates a predetermined angle clockwise from the state shown in FIG. 17, the third commutator segment 28 is in contact with the power source side brush 18, and the second commutator segment 27 is in contact with the ground side brush 19, the inductance between the brushes 18 and 19 is expressed by an inductance Lf. When the motor 120 further rotates clockwise, the third commutator segment 28 is in contact with the power source side brush 18, and the first commutator segment 26 is in contact with the ground side brush 19, the inductance between the brushes 18 and 19 is expressed by an inductance Lg. The relationship among the three inductances is Le>Lf>Lg.

Thus, while the motor 120 rotates 180 degrees and the contact relationship between the brushes 18 and 19 and the commutator segments 26-28 changes three times, the inductance of the motor circuit changes to three different values. The change in the inductance can be detected as a change in the amplitude of the alternating-current component of the electric current that flows in the motor 2. The change pattern of the amplitude of the alternating-current component depends on the rotation direction of the motor 120.

In a case where the motor 120 rotates clockwise, the inductance of the motor circuit changes in the order of Le, Lf, Lg, Le . . . . In a case where the motor 120 rotates counterclockwise, the inductance of the motor circuit changes in the order of Lg, Lf, Le, Lg . . . . The amplitude of the alternating-current component of the electric current that flows in the motor 120 also changes three stages in accordance with the inductance. Thus, the change pattern of the amplitude depends on the rotation direction of the motor 120.

Because the change pattern of the amplitude depends on the rotation direction of the motor 120, not only the rotation angle can be detected but also the rotation direction can be detected based on the change pattern.

In order to detect the rotation direction as well as the rotation angle, a part of the configuration of the signal processor 25 needs to be changed so that a signal corresponding to a change pattern of the envelope detection signal is output independently of or as a part of the rotation pulse in a manner similar to the fifth embodiment.

In the motor 120 according to the present embodiment, the inductance element 122 is coupled in parallel with the third phase coil L3, and the inductance element 123 is coupled in series with the first phase coil L1 so that each phase has a different inductance. Thus, the change pattern of the amplitude of the alternating-current component caused by the rotation of the motor 120 depends on the rotation direction of the motor 120. Because the rotation direction can be detected, a detection result of the rotation angle can be compensated based on a detection result of the rotation direction.

In the example shown in FIG. 17, the inductance element 123 is coupled in series with the first phase coil L1, and the inductance element 122 is coupled in parallel with the third phase coil L3. Both of the inductance elements 122 and 123 may also be coupled in series or both of the inductance elements 122 and 123 may also be coupled in parallel. As a connection method of coupling in parallel, an inductance element may also be coupled in parallel with a part of one of the phase coils L1-L3. Three inductance elements may also be coupled with respective phase coils L1-L3.

### Twelfth Embodiment

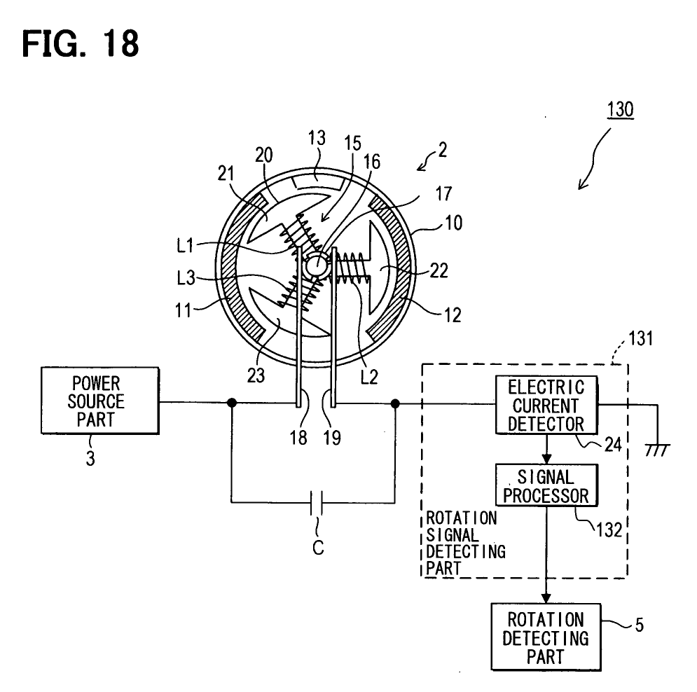

A rotation detecting apparatus 130 according to a twelfth embodiment of the present invention will be described with reference to FIG. 18. The rotation detecting apparatus 130 includes the motor 2, the power source part 3, a capacitor C, a rotation signal detecting part 131, and the rotation detecting part 5.

The capacitor C has a predetermined electrostatic capacity value and is coupled between the brushes 18 and 19. The rotation signal detecting part 131 includes the electric current detector 24 and a signal processor 132. The signal processor 132 is similar to the signal processor 25 shown in FIG. 4. However, the signal processor 132 includes a band pass filter (not shown) instead of the high pass filter 31.

The motor 2 can be seen as one inductance element from the standpoint of electricity. Thus, in the rotation detecting apparatus 130 according to the present embodiment, the motor 2 and the capacitor C coupled in parallel with the motor 2 form a parallel resonance circuit. The electric current detector 24 detects an electric current that flows from the power source part 3 through the parallel resonance circuit.

As described above, the inductance of the motor circuit between the brushes 18 and 19 changes in two stages while the motor 2 rotates 180 degrees. Thus, an impedance of the parallel resonance circuit formed by motor 2 and the capacitor C changes in stages while the motor 2 rotates 180 degrees.

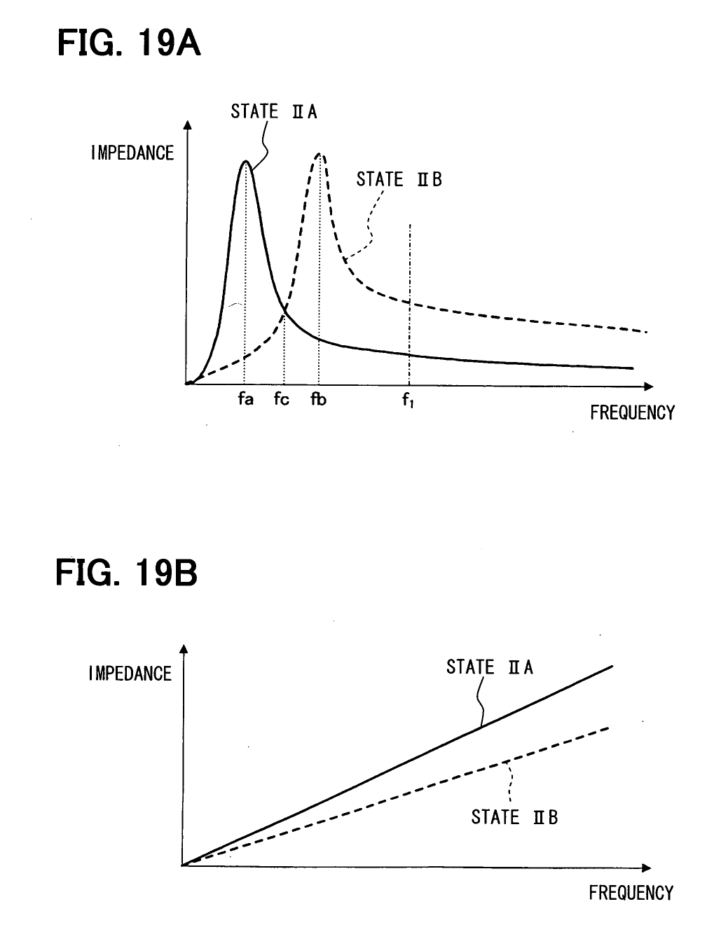

As shown in FIG. 19A, the impedance of the parallel resonance circuit has different frequency characteristics between the state IIA and the state IIB. In the state IIA, the impedance of the parallel resonance circuit becomes a maximum value at a resonant frequency fa. In the state IIB, the impedance of the parallel resonance circuit becomes a maximum value at a resonant frequency fb.

In the state IIA where one of the teeth 21-23 of the rotor core 20 is opposite the protruding portion 13, the inductance of the motor circuit is larger than the inductance in the state IIB where none of the teeth 21-23 is opposite the protruding portion 13. The resonant frequency of the parallel resonance circuit decreases when the inductance of the motor circuit increases. Thus, the resonant frequency fa in the state IIA is lower than the resonant frequency fb in the state IIB.

In a case where the motor 2 is alone, the impedance of the motor circuit is proportional to the frequency, and the impedance increases as the frequency increases a shown in FIG. 19B. In this case, the impedance in the state IIA is larger than the impedance in the state IIB.

In the rotation detecting apparatus 130 according to the present embodiment, the parallel resonance circuit is formed by coupling the capacitor C in parallel with the motor circuit. Thus, as shown in FIG. 19A, in a frequency band higher than the resonant frequency, the impedance of the parallel resonance circuit decreases as the frequency increases. In a frequency band higher than the resonant frequency fb in the state IIB, the impedance in the state IIB is larger than the impedance in the state IIA, and the difference between the impedance in the state IIB and the impedance in the state IIA is large. In a case where the motor 2 is alone, the frequency needs to be increased to make the difference in the impedance larger.

Due to the difference in the frequency characteristics, in the rotation detecting apparatus 130 according to the present embodiment, the amplitude of the alternating-current component becomes larger than that of the rotation detecting apparatus 1 according to the first embodiment.

As shown in FIG. 19A, in the frequency band higher than the resonant frequency fb in the state IIB, the impedance decreases as the frequency increases. The amplitude of the alternating-current component increases as the impedance decreases. Thus, the rotation signal detecting part 131 can detect the alternating-current component having a large amplitude and can generate a rotation pulse with a high degree of accuracy based on the alternating-current component.

In the present embodiment, the alternating-current component generator 7 in the power source part 3 generates an alternating-current voltage having a sine waveform at a frequency f1. Thus, the electric current detected by the electric current detector 24 includes an alternating-current component having the sine waveform at the frequency f1. As shown in FIG. 19A, the frequency f1 is higher than the resonant frequency fb in the state IIB.

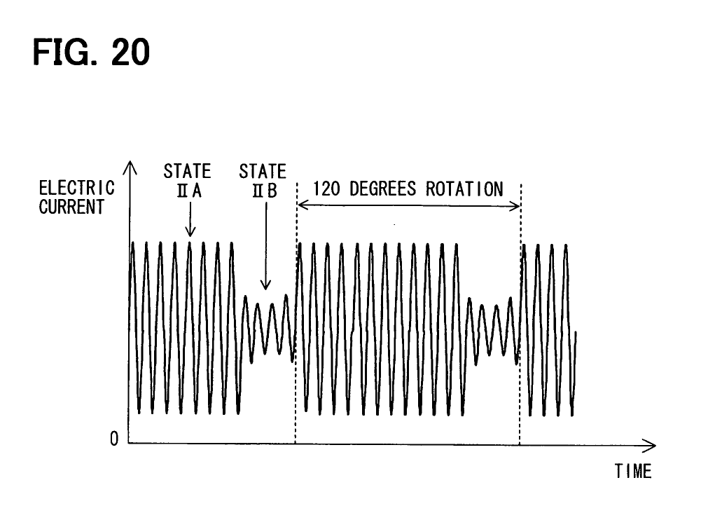

As shown in FIG. 20, in the state IIA where the impedance of the parallel resonance circuit is small, the amplitude of the alternating-current component of the electric current detected by the electric current detector 24 becomes large. In the state IIB where the impedance of the parallel resonance circuit is large, the amplitude of the alternating-current component of the electric current detected by the electric current detector 24 becomes small.

From the electric current detected by the electric current detector 24, the signal processor 132 extracts a component having a predetermined frequency including the frequency f1, that is, the alternating-current component, by the band pass filter. The extracted alternating-current component is treated with an amplification, an envelope detection, a comparison with a threshold value in a manner similar to the first embodiment and a rotation pulse is generated.

In the above-described example, the signal processor 132 extracts the alternating-current component by the band pass filter. The signal processor 132 may also extract the alternating-current component by a high pass filter in a manner similar to the signal processor 25 according to the first embodiment. In the rotation detecting apparatus 130 according to the present embodiment, the motor 2 and the capacitor C form the parallel resonance circuit. Thus, even if the frequency of the alternating-current component increases, the amplitude of the alternating-current component can be restricted from becoming small, and the change in the amplitude due to the rotation of the motor 2 can be large. Thus, the detection accuracy of the rotation state including the rotation angle can be improved.

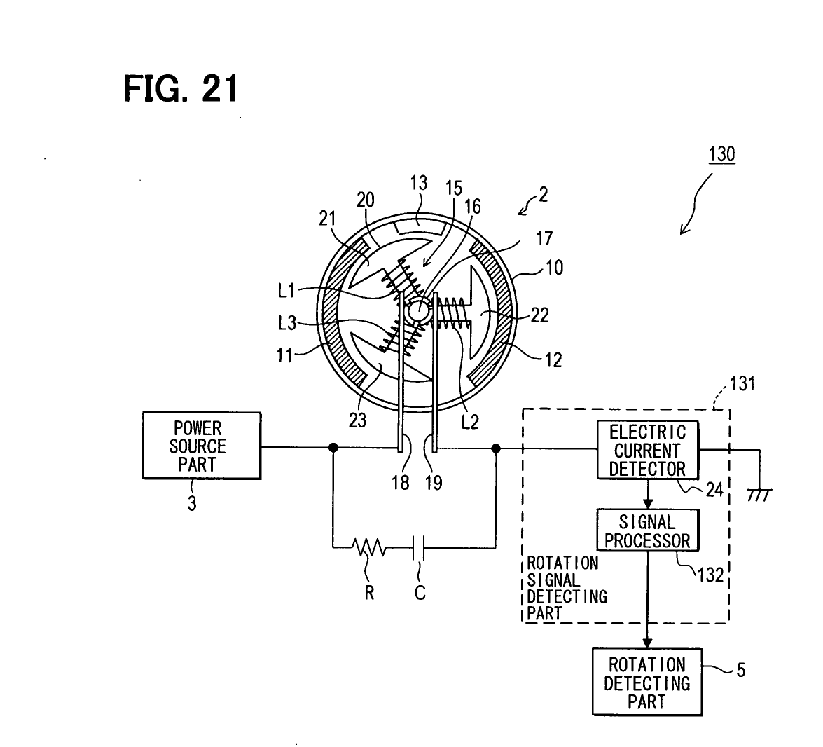

A rotation detecting apparatus 130 may further includes a resistor R as shown in FIG. 21. The resistor R is coupled between the brushes 18 and 19 in series with the capacitor C. In the present case, the rotation detecting apparatus 130 can control an amplitude of a high-frequency current that naturally flows due to a charge and discharge of the capacitor C when the motor 2 rotates. An inductance element may also be coupled instead of the resistor R.

### Thirteenth Embodiment

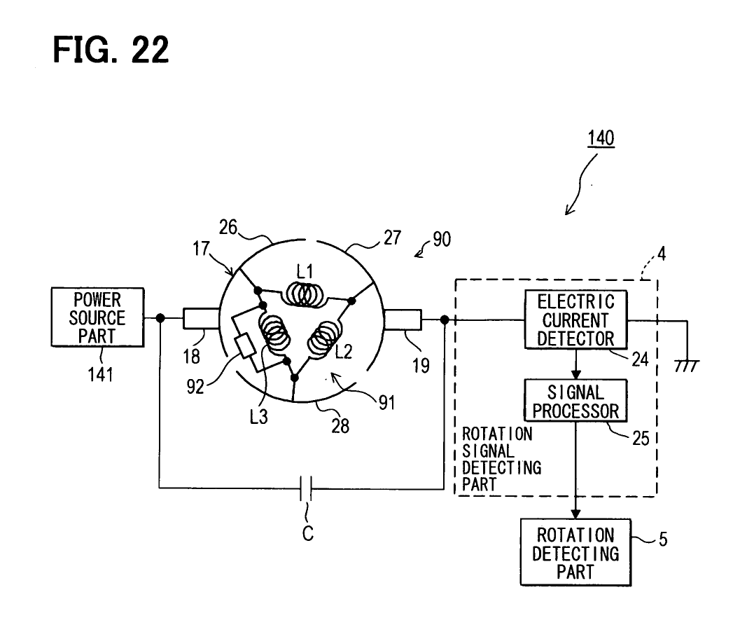

A rotation detecting apparatus 140 according to a thirteenth embodiment of the present invention will be described with reference to FIG. 22.

The rotation detecting apparatus 140 includes a power source part 141, the motor 90, the capacitor C, the rotation signal detecting part 4, and the rotation detecting part 5. In the motor 90, the inductance element 92 is coupled in parallel with the third phase coil L3 as described in the eighth embodiment. While the motor 90 rotates 180 degrees, the state of the motor circuit changes among the three states, and the inductance of the motor 90 changes in two stages. That is, the inductance is large when the motor 90 is in the state XIIIA (XIIIa) or the state XIIIC (XIIIc), and the inductance is small when the motor 90 is in the state XIIIE (XIIIe).

The capacitor C is coupled between the brushes 18 and 19 in a manner similar to the twelfth embodiment. Thus, the motor 90 and the capacitor C coupled in parallel with the motor 90 form a parallel resonance circuit. The electric current detector 24 detects an electric current that flows from the power source part 141 through the parallel resonance circuit.

Because the inductance of the motor 90 changes in two stages while the motor 90 rotates 180 degrees, the impedance (resonance characteristic) of the parallel resonance circuit also changes in two stages. When the inductance of the motor 90 is large, the resonant frequency becomes low, and when the inductance of the motor 90 is large, the resonant frequency becomes high.

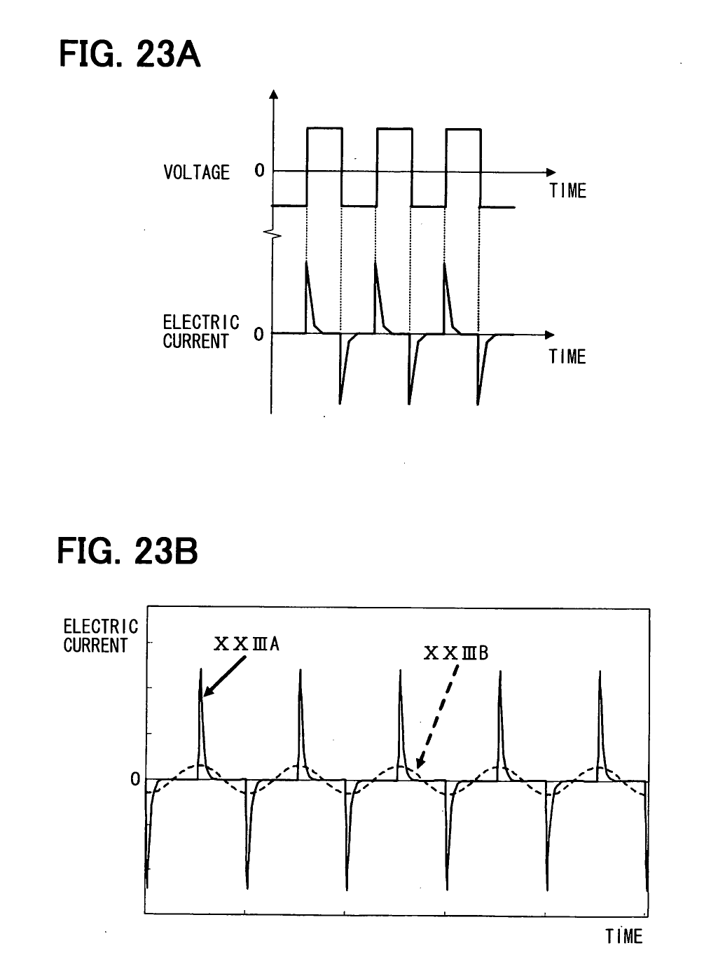

The power source part 141 includes an alternating-current component generator that generates an alternating-current voltage having a rectangular waveform as shown in FIG. 23A. Thus, an alternating current output through the coupling capacitor C1 has an approximately impulse waveform as shown in FIG. 23A.

The alternating current does not always have the approximately impulse waveform as shown in FIG. 23A. The waveform of the alternating current depends on the rotation angle of the motor 90 and a circuit constant of a circuit other than the motor 90. As shown in FIG. 23B, when amplitudes of both alternating-current voltages are the same, a peak value of the alternating-current component (XXIIIA) included in the electric current that flows to the motor 90 in a case where the alternating-current component generator generates the alternating-current voltage having a rectangular waveform and the alternating-current voltage is superimposed through the coupling capacitor C1 is larger than a peak value of the alternating-current component (XXIIIB) included in the electric current in a case where the alternating-current component generator generates the alternating-current voltage having a sine waveform and the alternating-current voltage is superimposed through the coupling capacitor C1.

Thus, in a case where the alternating-current voltages having the same amplitude are output through the coupling capacitor C1, the alternating current when the alternating-current voltage has the rectangular waveform can have the larger amplitude than the amplitude of the alternating current when alternating-current voltage has the sine waveform. Thus, when the alternating-current voltage has the rectangular waveform, the rotation state including the rotation angle can be detected with a high degree of accuracy.

Furthermore, when the alternating-current component generator generates the alternating-current voltage having the rectangular waveform and the alternating-current voltage is superimposed through the coupling capacitor C1, the superimposed alternating current has the approximately impulse shape as shown in FIG. 23A. Thus, the alternating current includes high order harmonic component in addition to a fundamental frequency f1 that is the frequency of the alternating-current voltage having the rectangular waveform.

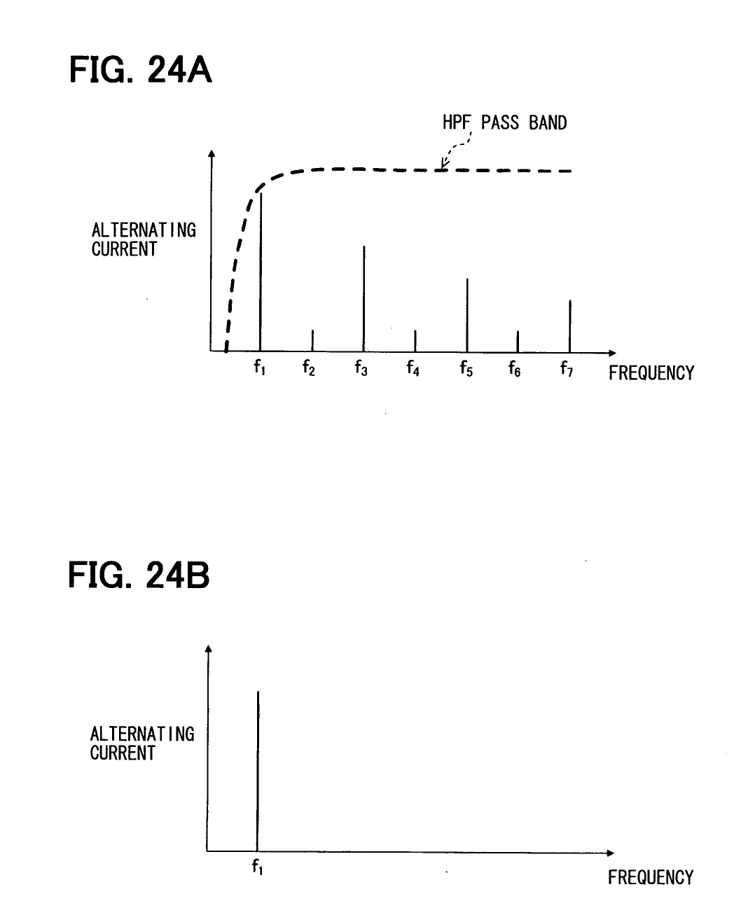

As shown in FIG. 24A, the alternating current has n-time waves having frequencies of n times larger than the fundamental frequency f1, where “n” is a natural number greater than or equal to two. Especially, electric currents of a fundamental component (f1) and odd number-time wave components (f3, f5, f7 . . . ) become large.

When the alternating-current component generator generates the alternating-current voltage having the sine waveform and the alternating-current voltage is superimposed through the coupling capacitor C1, the superimposed alternating current has the sine waveform. Thus, as shown in FIG. 24B, the alternating current basically has only the frequency f1 of the sine wave. Although the alternating current includes harmonic components other than the frequency f1, levels of the harmonic components are much smaller than levels of the harmonic components generated in a case where the alternating-current component generator generates the alternating-current voltage having the rectangular waveform.

In the present embodiment, by applying the alternating-current voltage having the rectangular waveform through the coupling capacitor C1, the alternating current having the large amplitude and including the high order harmonic component is superimposed. The fundamental frequency f1 of the alternating current is higher than the resonant frequency of the parallel resonance circuit.

As described above, in the band higher than the resonant frequency, the impedance of the parallel resonance circuit decreases as the frequency increases. The amplitude of the alternating current increases as the impedance decreases. Thus, the alternating-current component of the fundamental frequency f1 and the high order harmonic component can be detected with certainty.

In a case where the capacitor C1 is not provided and the motor 90 is alone, the impedance increases in proportional to the frequency as shown in FIG. 19B. Thus, the superimposed alternating current becomes difficult to flow as the frequency increases, and it becomes difficult to detect the change in the amplitude.

In the rotation detecting apparatus 140 according to the present embodiment, the parallel resonance circuit is formed by coupling the capacitor C, and the impedance is small even when the frequency high. Thus, the alternating current including the high order harmonic component as well as the fundamental component can flow at a sufficient level. As a result, the change in the amplitude can be detected with accuracy.

The high pass filter 31 in the signal processor 25 has a cutoff frequency lower than the fundamental frequency f1 of the alternating current as shown by a dashed line in FIG. 24A. Thus, signals in a frequency band higher than the cutoff frequency can pass through the high pass filter 31.

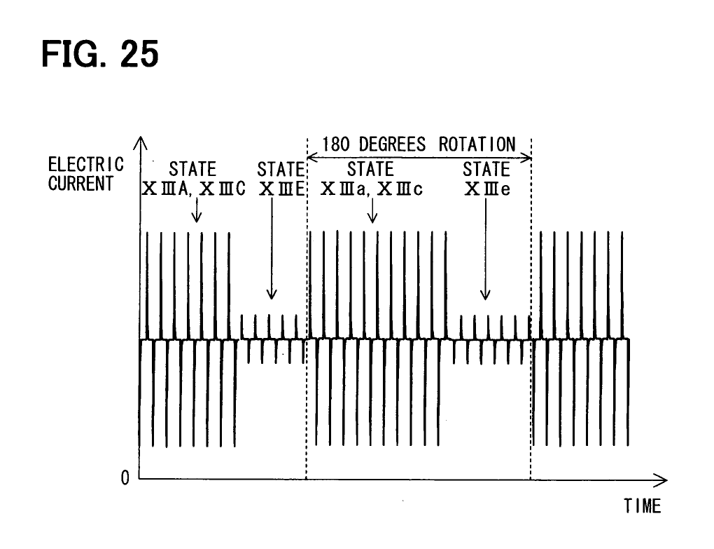

As shown in FIG. 25, the amplitude of the alternating-current component in the electric current detected by the electric current detector 24 becomes large in the state XIIIA, XIIIC, XIIIa, and XIIIc where the impedance of the parallel resonance circuit becomes small, and the amplitude of the alternating-current component becomes small in the state XIIIE and XIIIe where the impedance of the parallel resonance circuit becomes large.

The signal processor 25 extracts the fundamental frequency f1 and the harmonic component (that is, all the alternating-current component) from the electric current detected at the electric current detector 24 by using the high pass filter 31. The extracted alternating-current component is treated with an amplification, an envelope detection, a comparison with a threshold value in a manner similar to the first embodiment and a rotation pulse is generated.

In the above-described example, the alternating-current component is extracted by using the high pass filter 31 in the signal processor 25. Other filters such as a band pass filter may also be used instead of the high pass filter 31. In the rotation detecting apparatus 140 according to the present embodiment, the motor 90 and the capacitor C form the parallel resonance circuit. Thus, even if the frequency of the alternating-current component increases, the amplitude of the alternating-current component can be restricted from becoming small, and the change in the amplitude due to the rotation of the motor 90 can be large. Thus, the detection accuracy of the rotation state including the rotation angle can be improved.

In general motors, especially, in medium-sized motors and large-sized motors, a capacitor is often coupled between brushes, for example, for absorbing a surge caused during rotation. Thus, when the capacitor is provided, for example, for absorbing a surge, a rotation state including a rotation angle can be detected in a manner similar to the present embodiment by changing a configuration of the motor so that an inductance periodically changes in accordance with the rotation of the motor.

### Other Embodiments

Although the present invention has been fully described in connection with the preferred embodiments thereof with reference to the accompanying drawings, it is to be noted that various changes and modifications will become apparent to those skilled in the art.

In each of the first to the fifth embodiments and the seventh embodiment, one protruding portion is provided in one clearance region between the magnets. A plurality of protruding portions may also be provided in one clearance region. In each of the first to the seventh embodiments, the protruding portion may be provided in any clearance region in a plurality of clearance regions. For example, the protruding portion may also be provided all the clearance regions or the protruding portion may also be provided only in one or more predetermined clearance regions.

In each of the first to the seventh embodiments and the twelfth embodiment, the motor includes the protruding portion on the housing side so that inductance changes with the rotation of the motor. In each of the eighth to the eleventh embodiments and the thirteenth embodiment, the motor includes the inductance element therein so that the inductance changes with the rotation of the motor. The above-described configurations may be combined. That is, a motor may include both of a protruding portion provided on a housing side and an inductance element coupled inside the motor.

In each of the above-described embodiments, the phase coils L1-L3 have the delta connection, as an example. The phase coils L1-L3 may also have a star connection. In a case where the phase coils L1-L3 has a star connection, an inductance element may be coupled in parallel or series with one of the phase coils L1-L3, an inductance element may also be coupled in parallel with a part of one of the phase coils L1-L3, more than one inductance elements may also be coupled with respective phase coils, or an inductance element may also be coupled between two commutator segments, for example. As long as an inductance changes in accordance with a rotation of a motor, the motor can have various configurations.

In each of the twelfth embodiment and thirteenth embodiment, the capacitor C is coupled between the brushes 18 and 19 so that the capacitor C and the motor circuit form the parallel resonance circuit. In general, a capacitor is often coupled between brushes for reducing noise (surge) generated when a positional relationship between the brushes and the commutator segments changes. When the capacitor is provided for reducing noise, the capacitor can be used as the capacitor C in each of the twelfth embodiment and the thirteenth embodiment.

While a motor is rotating, there is a changing term where one brush is in contact with two adjacent commutator segments at the same time. The inductance between the brushes also changes during the changing time. However, the changing term momentarily occurs while the motor rotates one revolution, and the change in the inductance in the changing term is also momentary. Therefore, the changing term is not considered in each of the above-described embodiments.

However, although it is momentary, the change in the inductance certainly occurs during the changing term. Thus, the rotation state including the rotation angle can be detected based on a momentary change in the amplitude of the alternating-current component caused by the change in the inductance. In other words, the rotation state including the rotation angle can be detected based on the change in the inductance during the changing term without providing the protruding portion on the housing side and inductance element in the motor.

In each of the above-described embodiments, the number of phases of the armature coil is three, as an example. However, the number of the phases is not limited to three and may be four or more.

In each of the above-described embodiments, a two-pole motor including two magnets 11 and 12 is used as an example. A motor having the number of poles other than two such as a four-pole motor and a six-pole motor may also be used.

As long as a motor is configured so that an inductance of a motor circuit periodically changes in accordance with a rotation of the motor, a rotation state including a rotation angle can be detected regardless of the number of phases, the number of poles, and the number of slots.

A rotation state to be detected can be set optionally. A rotation detecting apparatus is configured to detect at least one of a rotation angle, a rotation speed, and a rotation direction of a motor.

In each of the above-described embodiments, the direct-current power source 6 and the alternating-current component generator 7 are independently provided in the power source part 3 and the output voltages from the direct-current power source 6, and the alternating-current component generator 7 are superimposed through the coupling capacitor C1 and are applied to the motor. The power source part 3 may also have other configurations.

For example, a power source device that generates a voltage in which a direct-current voltage and an alternating-current voltage are superimposed may also be used. An alternating-current voltage may also be superimposed by a magnetic coupling using a transformer, or an alternating-current voltage may also be superimposed by radio wave. As long as an alternating-current component can be included in an electric current that flows to a motor, a configuration of the power source part 3 is not limited. A voltage generated by the alternating-current component generator may have various waveforms including a sine waveform and a rectangular waveform.

What is claimed is:

1. A rotation detecting apparatus comprising:
a direct-current motor including a housing, a plurality of magnets, a rotor core, a commutator, and a pair of brushes, the plurality of magnets fixed on an inner surface of the housing and arranged in a circumferential direction of the housing, the rotor core disposed in the housing and including an armature coil having a plurality of phase coils, the commutator including a plurality of commutator segments coupled with the armature coil, the pair of brushes slidingly contacting the commutator, the direct-current motor configured so that an inductance between the pair of brushes periodically changes in accordance with a rotation of the rotor core;
a power source part configured to apply a power source voltage between the pair of brushes, the power source voltage including an alternating-current voltage superimposed on a direct-current voltage;
an energization detecting part configured to detect an electric quantity related to the alternating-current voltage applied from the power source part to the direct-current motor; and
a rotation state detecting part configured to detect at least one of a rotation angle, a rotation direction, and a rotation speed of the direct-current motor based on a change in an amplitude of an alternating-current component in the electric quantity detected by the energization detecting part.

2. The rotation detecting apparatus according to claim 1, wherein:
the inner surface of the housing has a plurality of clearance regions provided between adjacent two of the plurality of magnets in the circumferential direction;
the direct-current motor further includes a protruding portion; and
the protruding portion has a soft magnetic property and protrudes radially inward from one of the plurality of clearance regions.

3. The rotation detecting apparatus according to claim 2, wherein
the direct-current motor further includes another protruding portion, and
the another protruding portion has a soft magnetic property and protrudes radially inward from another one of the plurality of clearance regions.

4. The rotation detecting apparatus according to claim 3, wherein
the one of the plurality of clearance regions from which the protruding portion protrudes and the another one of the plurality of clearance regions from which the another protruding portion protrudes are opposite each other in a radial direction of the housing.

5. The rotation detecting apparatus according to claim 2, wherein
the protruding portion is configured so that a change pattern of the inductance depends on the rotation direction of the direct-current motor, and
the rotation state detecting part detects the rotation direction of the direct-current motor based on a change pattern of the amplitude of the alternating-current component.

6. The rotation detecting apparatus according to claim 5, wherein
the protruding portion has a shape that is determined so that a distance between the protruding portion and the rotor core changes in the circumferential direction, and a change pattern of the distance differs between one direction of the circumferential direction and the other direction of the circumferential direction.

7. The rotation detecting apparatus according to claim 5, wherein
the protruding portion includes two protruding elements having different magnetic permeabilities, and
the two protruding elements are arranged next to each other in the circumferential direction.

8. The rotation detecting apparatus according to claim 2, wherein
the protruding portion is formed by protruding a part of the housing radially inward.

9. The rotation detecting apparatus according to claim 1, wherein
the protruding portion is apart from the plurality of magnets in the circumferential direction.

10. The rotation detecting apparatus according to claim 1, wherein
the direct-current motor further includes an inductance element, and
the inductance element is coupled in parallel with a part or whole of one of the plurality of phase coils or in series with one of the plurality of phase coils.

11. The rotation detecting apparatus according to claim 10, wherein:
the direct-current motor further includes another inductance element;
the another inductance element is coupled with another one of the plurality of phase coils;
a combined inductance of the one of the plurality of phase coils and the inductance element and a combined inductance of the another one of the plurality of phase coils and the another inductance element are different from each other; and
the rotation state detecting part is configured to detect the rotation direction based on a change pattern of the amplitude of the alternating-current component.

12. The rotation detecting apparatus according to claim 1, wherein
the armature coil has three phase coils.

13. The rotation detecting apparatus according to claim 11, wherein
the armature coil has three phase coils; and
the inductance element and the another inductance element are respectively coupled with two of the three phase coils.

14. The rotation detecting apparatus according to claim 1, further comprising
a capacitance element disposed outside the direct-current motor and coupled between the pair of brushes, wherein
the capacitance element and the direct-current motor form a parallel resonance circuit, and
the energization detecting part is configured to detect an electric quantity relating to the alternating-current voltage applied from the power source part to the parallel resonance circuit.

15. The rotation detecting apparatus according to claim 14, further comprising
a resistor element coupled between the pair of brushes in series with the capacitance element.

16. The rotation detecting apparatus according to claim 1, wherein the power source part including:
a direct-current power source configured to generate the direct-current voltage;
an alternating-current power source configured to generate the alternating-current voltage; and
a superimposing portion configured to superimpose the alternating-current voltage generated by the alternating-current power source on the direct-current voltage generated by the direct-current power source.

17. A direct-current motor comprising:
a housing;
a plurality of magnets fixed on an inner surface of the housing and arranged in a circumferential direction of the housing;
a rotor core disposed in the housing and including an armature coil having a plurality of phase coils;
a commutator including a plurality of commutator segments coupled with the armature coil; and
a pair of brushes slidingly contacting the commutator, wherein
an inductance between the pair of brushes periodically changes in accordance with a rotation of the rotor core.

18. The direct-current, motor according to claim 17, further comprising
a protruding portion having a soft magnetic property, wherein
the inner surface of the housing has a plurality of clearance regions provided between adjacent two of the plurality of magnets in the circumferential direction, and
the protruding portion protrudes radially inward from one of the plurality of clearance regions.

19. The direct-current motor according to claim 17, further comprising
an inductance element coupled in parallel with a part or whole of one of the plurality of phase coils or in series with one of the plurality of phase coils.
